(19) United States
(12) Patent Application Publication
(10) Pub. No.: US 2017/0291372 A1
(43) Pub. Date: Oct. 12, 2017

(54) GENERATING THREE-DIMENSIONAL OBJECTS BY THREE-DIMENSIONAL PRINTING WITH ROTATION

(71) Applicant: Velo3D, Inc., Campbell, CA (US)

(72) Inventors: Erel MILSHTEIN, Cupertino, CA (US); Benyamin BULLER, Cupertino, CA (US)

(21) Appl. No.: 15/479,531

(22) Filed: Apr. 5, 2017

Related U.S. Application Data
(60) Provisional application No. 62/320,453, filed on Apr. 9, 2016.

(51) Int. Cl. B29C 67/00; B33Y 30/00; G05B 19/4099; B33Y 70/00; B22F 3/105; B28B 1/00; B33Y 10/00; B33Y 50/02

(52) U.S. Cl. CPC B29C 67/0092; B33Y 10/00; B33Y 30/00; B33Y 50/02; B33Y 70/00; B22F 3/1055; B28B 1/001; B29C 67/0088; B29C 67/0077; G05B 19/4099; B22F 2003/1057; B22F 2003/1058; G05B 2219/35134; G05B 2219/49007

(57) ABSTRACT

The present disclosure provides three-dimensional (3D) printing methods, apparatuses, systems and software that comprise rotating a partially formed 3D object during the formation of a requested 3D object. The requested 3D object may comprise a cavity, an intrusion, or a protrusion. The rotation may be along an axis other than a vertical axis.

### CROSS-REFERENCE

This application claims priority to U.S. Provisional Patent Application Ser. No. 62/320,453, filed on Apr. 9, 2016, which is entirely incorporated herein by reference.

### BACKGROUND

Three-dimensional (3D) printing (e.g., additive manufacturing) is a process for making a three-dimensional (3D) object of any shape from a design. The design may be in the form of a data source such as an electronic data source, or may be in the form of a hard copy. The hard copy may be a two-dimensional representation of a 3D object. The data source may be an electronic 3D model. 3D printing may be accomplished through an additive process in which successive layers of material are laid down one on top of each other. This process may be controlled (e.g., computer controlled, manually controlled, or both). A 3D printer can be an industrial robot.

3D printing can generate custom parts quickly and efficiently. A variety of materials can be used in a 3D printing process including elemental metal, metal alloy, ceramic, elemental carbon, or polymeric material. In a typical additive 3D printing process, a first material-layer is formed, and thereafter, successive material-layers (or parts thereof) are added one by one, wherein each new material-layer is added on a pre-formed material-layer, until the entire designed three-dimensional structure (3D object) is materialized.

3D models may be created utilizing a computer aided design package or via 3D scanner. The manual modeling process of preparing geometric data for 3D computer graphics may be similar to plastic arts, such as sculpting or animating. 3D scanning is a process of analyzing and collecting digital data on the shape and appearance of a real object. Based on this data, 3D models of the scanned object can be produced. The 3D models may include computer-aided design (CAD).

A large number of additive processes are currently available. They may differ in the manner layers are deposited to create the materialized structure. They may vary in the material or materials that are used to generate the designed structure. Some methods melt or soften material to produce the layers. Examples for 3D printing methods include selective laser melting (SLM), selective laser sintering (SLS), direct metal laser sintering (DMLS), shape deposition manufacturing (SDM) or fused deposition modeling (FDM). Other methods cure liquid materials using different technologies such as stereo lithography (SLA). In the method of laminated object manufacturing (LOM), thin layers (made inter alia of paper, polymer, metal) are cut to shape and joined together.

Some complex 3D object may comprise enlarged cavities having at least one substantially planar or nearly planar face. Some complex 3D objects may require a specific (e.g., preferred) print orientation according to which the printing should progress (e.g., due to material strength constraints). For example, the desired 3D object may comprise a desired axis along which the printing should ideally progress. A model of the desired 3D object may be aligned according to this specific orientation. Subsequent thereto, the model of the 3D object may exhibit a substantially planar (e.g., flat) or nearly planar surfaces in both the top and bottom of the 3D object. The printing process of such structures may be challenging and require support structures (e.g., within the cavity) which are difficult and/or impossible to remove. At times, the 3D object may comprise one or more embossed surface. At least one embossed surface may be a hanging surface (e.g., a ledge or a shelf). At least one of the embossed surfaces may comprise an angular material portion. The present disclosure delineates methods, systems, apparatuses and/or software that effectuate the generation of such 3D objects.

### SUMMARY

In some embodiments, the present disclosure delineates methods, systems, apparatuses, and software that allow modeling of 3D objects with a reduced amount of design constraints (e.g., no design constraints). The present disclosure delineates methods, systems, apparatuses, and software that allow materialization of these 3D object models. The realization may comprise printing the 3D object is two or more portions, wherein at least one step between the two or more portions comprises rotation of one of the two or more portions. The rotation may be prior to the completion of the requested 3D object. For example, the rotation may be an Intermediate step during the 3D printing. The completion of the requested 3D object may comprise 3D printing prior to and/or following the rotation. The rotation may be about an axis that is different from a vertical axis. For example, the axis may be a horizontal axis.

In an aspect described herein are methods, systems, apparatuses, and/or software for generating a 3D object having at least one (e.g. at least two) embossed surfaces and/or at least one cavity. The requested 3D object may be a complex 3D object.

In an aspect, a method of forming a three-dimensional (3D) object having a cavity and at least one embossed surfaces comprising: (a) modifying the model of a desired (e.g., requested) 3D object to form a second model comprising a redacted embossed portion and a first model of a modified 3D object that excludes the redacted embossed portion; (b) generating the modified 3D object in an enclosure according to the first model of the modified 3D object by using a first 3D printing methodology, which modified 3D object is anchored to the enclosure, which modified 3D object is generated in a first material bed; (c) removing the modified 3D object from the first material bed (e.g., and from the enclosure); (c) rotating the modified 3D object at an angle and disposing the modified 3D object that has been rotated in a second material bed; and (d) generating the redacted embossed portion according to the second model of the redacted embossed portion from at least a portion of the second material bed by using a second 3D printing methodology, which redacted embossed portion is attached to the modified 3D object to form the requested three-dimensional object. The enclosure may comprise a platform. Anchored can comprise attached to the platform. The first material bed may comprise a pre-transformed material. The second material bed may comprise a pre-transformed material. The first material bed may be the same as the second material bed. The first material bed may be different from the second material bed. The method may further comprise (e.g., after operation (a), (b), (c), (d), or before operation (b) or (d): adjusting the relative position of the (e.g., first and/or second) material bed to allow deposition of at least one layer of pre-transformed material.

In another aspect, a method for printing a three-dimensional object comprises: (a) modifying a first model of a requested three-dimensional object to form (i) a second model of the requested three-dimensional object from which a segment is omitted, and (ii) a third model of the segment; (b) printing a modified three-dimensional object above a platform according to the second model, which printing comprises a first three-dimensional printing methodology; (c) rotating the modified three-dimensional object relative to the platform; and (d) printing the segment according to the third model by using a second three-dimensional printing methodology, which printing comprises attaching the segment to the modified three-dimensional object to form the requested three-dimensional object.

The first model, second model, and third model may be virtual models. The rotation of the modified three-dimensional object may be about an axis that is not perpendicular to the platform. The axis may form an acute angle alpha with the platform and/or with the gravitational vector. The angle alpha may be at least ten (10) degrees. Alpha may be about ninety (90) degrees. The platform may be stationary during the printing in operation (b) and/or operation (d). The platform may be vertically translatable. The platform may not be rotatable. The platform may be rotatable. The rotating may be about a horizontal axis. The printing may be adjacent to a platform. The rotating may be about an axis that is parallel to the platform. The rotating may be about an axis different from a vertical axis. The printing may be adjacent to a platform. The rotating may be about an axis that is not perpendicular to the platform. Adjacent may be above. The segment may comprise a protrusion. The printing in operation (b) and/or in operation (d) may comprise using a material bed. A pre-transformed material in the material bed may be flowable during the printing in operation (b) and/or in operation (d). The material bed may be at ambient pressure during the printing in operation (b) and/or in operation (d). The material bed may be devoid of substantial gradients during the printing in operation (b) and/or in operation (d). The material bed may be devoid of substantial pressure gradients during the printing in operation (b) and/or in operation (d). The printing in operation (b) may comprise using a first material bed. The modified three-dimensional object from the first material bed may be removed before operation (d). The modified three-dimensional object from the first material bed may be removed after operation (b). The printing in operation (d) may comprise using a second material bed to print the requested three-dimensional object. The printing in operation (b) may comprise using a first material bed and the printing in operation (d) may comprise using a second material bed. The second material bed may be substantially the same as the first material bed. The second material bed may be different than the first material bed. The second material bed may be different than the first material bed in operation (i) a fundamental length scale, material composition, or material form. The material form may comprise a material phase. The material form may comprise an average fundamental length scale of a particulate material type that is included in the material bed. The first three-dimensional printing methodology and the second three-dimensional printing methodology may be the same. The first three-dimensional printing methodology and the second three-dimensional printing methodology may be different. The modified three-dimensional object may be anchored to the platform during the printing in operation (b). The modified three-dimensional object may be directly anchored to the platform during the printing in operation (b). The modified three-dimensional object may be anchored to the platform by one or more auxiliary supports during the printing in operation (b). The modified three-dimensional object may be suspended anchorless above the platform during the printing in operation (b). The modified three-dimensional object may be suspended anchorless in a material bed during the printing in operation (b). The requested three-dimensional object may not be anchored to the platform during the printing in operation (d). The requested three-dimensional object may contact the platform during the printing in operation (d). The contacts to the platform may exclude connect to the platform. The requested three-dimensional object may rest on the platform during the printing in operation (d). The modified three-dimensional object may not be anchored to the platform during the printing in operation (b). The modified three-dimensional object may contact the platform during the printing in operation (b). The modified three-dimensional object may rest on the platform during the printing in operation (b). The first three-dimensional printing methodology and/or the second three-dimensional printing methodology may comprise additive manufacturing. The first three-dimensional printing methodology and/or the second three-dimensional printing methodology may comprise using a material bed. The first three-dimensional printing methodology and/or the second three-dimensional printing methodology may comprise using a particulate material. The particulate material may comprise a powder material. The particulate material may comprise a at least one member selected from the group consisting of elemental metal, metal alloy, ceramic, allotrope of elemental carbon, polymer, or a resin. The particulate material may comprise a at least one member selected from the group consisting of elemental metal, metal alloy, ceramic, or an allotrope of elemental carbon. The first three-dimensional printing methodology may comprise using an energy beam. The energy beam may comprise an electromagnetic beam or a charged particle beam. The first three-dimensional printing methodology may comprise using an energy beam to irradiate a pre-transformed material to form a transformed material as part of the three-dimensional object. The pre-transformed material may be disposed towards the platform. The pre-transformed material may be transformed to the transformed material (I) during its disposal towards the platform or (II) as it contacts the platform. The pre-transformed material may be disposed in a material bed. The pre-transformed material may be transformed to the transformed material in the material bed. The transformed may comprise fused or connected. Fused may comprise sintered or melted. Melted may comprise completely melted. Connected may comprise chemically connected. Transformed may comprise physically transformed or chemically transformed. The requested three-dimensional object may comprise a cavity. The cavity may comprise a symmetric cross section. The cavity may comprise an asymmetric cross section. The cavity volume may be at least about 20 percent of the volume of the requested three-dimensional object. Printing the three-dimensional object according to the first model may require addition of one or more auxiliary supports in the cavity. The cavity may be printed without the one or more auxiliary supports. The cavity may comprise an interior surface having a first normal to the interior surface at a first position. The angle between the first normal and the shortest line between the position and the center of the cavity may be at most about 30 degrees. The interior surface may have a second normal to the interior surface at a second position. The angle between the second normal and the shortest line between the position and the center of the cavity may be at most about 30 degrees. The shortest distance between the first position and the second position may be at least about two (2) millimeters. The cavity may comprise an interior surface having a first normal to the interior surface at a first position. The angle between the first normal and the direction of the gravitational acceleration vector at a spatial configuration of the requested three-dimensional object, may be at most about 30 degrees. The interior surface may comprise a second normal to the interior surface at a second position. The angle between the second normal and the direction of the gravitational acceleration vector may be at most about 30 degrees, at a spatial configuration of the requested three-dimensional object. The spatial configuration may be the natural spatial configuration of the three-dimensional object. Natural may be according to the intended use of the requested three-dimensional object. Natural may be according to the center of mass of the requested three-dimensional object. Bottom may be in the direction of the gravitational center. The modified three-dimensional object may serve as a base for printing the segment in operation (d). The segment may be printed as a continuation of the modified three-dimensional object in operation (d). The segment may be printed on the modified three-dimensional object in operation (d). Before operation (d) and/or during operation (d), aligners may be introduced that reduce movement of the modified three-dimensional object relative to the platform. Introducing may comprise printing using the second three-dimensional printing methodology. Aligners may be anchored to the base during the printing in operation (d). The method may further comprise before operation (d), aligning a position of the modified three-dimensional object that has been rotated in operation (c). The aligning may be aligning with respect to the horizontal plane and/or vertical plane. The alignment may be with respect to a plane parallel to: (1) the platform and/or (2) normal to the gravitational vector. The alignment may be with respect to a plane perpendicular to: (1) the platform and/or (2) normal to the gravitational vector. The method may further comprise identifying at least one position of the modified three-dimensional object and/or of the segment. The method may further comprise (e.g., after (b), and/or prior to (d)), identifying at least one position of the modified three-dimensional object that has been rotated. The at least one position may comprise an X, Y, or Z spatial position (e.g., coordinate). Identifying the at least one position may comprise image processing (e.g., using at least one optical sensor and/or detector). Identifying the at least one position may comprise using a metrological detector (e.g., height mapper).

In another aspect, a system for forming a three-dimensional object comprises: a platform above which at least a section of the three-dimensional object is printed; a first processor configured to accommodate a first model of a requested three-dimensional object; a second processor configured to accommodate a second model of the requested three-dimensional object from which a segment is omitted; a third processor configured to accommodate a third model of the segment; and at least one controller that is operatively coupled to the platform, the first processor, the second processor, and the third processor, which at least one controller is programmed to direct performance of the following operations: operation (i) direct the second processor, the first processor, the third processor, or any combination thereof, to modify the first model of the requested three-dimensional object to form the second model and the third model, operation (ii) direct a first printing of the modified three-dimensional object above the platform according to the second model, which first printing comprises a first three-dimensional printing methodology, and operation (iii) direct a second printing the segment according to the third model, which second printing comprises a second three-dimensional printing methodology, which second printing comprises attaching the segment to the modified three-dimensional object that has been rotated relative to the platform, to form the requested three-dimensional object.

The first model, second model, and third model may be virtual models. At least two of the first processor, the second processor, and the third processor may be the same processor. At least two of the first processor, the second processor, and the third processor may different processor. The first model, the second model, and the third model may be virtual models. The first processor, the second processor, and/or the third processor may comprise a non-transitory computer-readable medium in which program instructions are stored. The first model, the second model, and the third model may comprise a non-transitory computer-readable medium. The system may further comprise a 3D printer that is configured to print at least a portion of the 3D object (e.g., the modified 3D object and/or the segment). The controller may be operatively coupled to the 3D printer. The controller may further direct the 3D printer to print in operations (ii), in operation (iii), or both in operation (ii) and (iii). The first processor, the second processor, the third processor, or any combination thereof, may be configured to generate: (1) a first set of printing instructions according to the second model, (2) a second set of printing instructions according to the third model, or (3) a first set of printing instructions according to the second model and a second set of printing instructions according to the third model. The controller may direct in operation (ii) printing of the modified 3D object according to the second set of printing instructions. The first printing in (ii) may comprise the second set of printing instructions. The controller may direct in operation (iii) printing the segment according to the third set of printing instructions. The second printing in (iii) may comprise the third set of printing instructions. The first set of printing instructions may be generated from the first model. The second set of printing instructions and/or the third set of printing instructions may differ from the first set of printing instructions. The rotation of the modified three-dimensional object may be about an axis that is not perpendicular to the platform. The axis may form an acute angle alpha with the platform and/or with the gravitational vector. The angle alpha may be at least ten (10) degrees. Alpha may be about ninety (90) degrees. At least two of operation (i), operation (ii), and operation (iii) may be directed by the same controller. The at least one controller may be a plurality of controllers. The at least two of operation (i), operation (ii), and operation (iii) may be directed by different controllers. The segment may comprise a protrusion. An enclosure may be configured to accommodate a material bed. The material bed may be used for the first printing in operation (ii) and/or for the second printing in operation (iii). The material bed may be flowable during the printing in operation (ii) and/or operation (iii). During the second printing in operation (ii) and/or during the second printing operation (iii), the material bed may be at an ambient temperature. During the first printing in operation (ii) and/or during the second printing in operation (iii), the material bed may be at a temperature of at most 500 degrees Celsius. During the first printing in operation (ii) and/or during the second printing in operation (iii), the material bed may be at a temperature of at most 300 degrees Celsius. The material bed may comprise a pre-transformed material. The pre-transformed material in the material bed may be flowable during the first printing in operation (ii) and/or during the second printing in operation (iii). An enclosure may be configured to accommodate a first material bed. The printing in operation (ii) may comprise using the first material bed. The modified three-dimensional object may be removed from the first material bed before operation (iii). The first printing in operation (ii) may comprise using a first material bed. The modified three-dimensional object may be removed from the first material bed after operation (ii). An enclosure may be configured to accommodate a second material bed. The second printing in operation (iii) may comprise using the second material bed to print the requested three-dimensional object. An enclosure may be configured to accommodate a first material bed and a second material bed. The first printing in operation (ii) may comprise using the first material bed and the second printing in operation (iii) may comprise using the second material bed. The enclosure may have an interior atmosphere that may be at ambient pressure during the first printing in operation (ii) and/or during the second printing operation (iii). The requested three-dimensional object may comprise a cavity. The cavity may comprise a symmetric cross section. The cavity may comprise an asymmetric cross section. The cavity volume may be at least about 20 percent of the volume of the requested three-dimensional object. The three-dimensional object according to the first model may require addition of one or more auxiliary supports in the cavity. The system may facilitate printing the cavity without the one or more auxiliary supports. The cavity may comprise an interior surface having a first normal to the interior surface at a first position. The angle between the first normal and the shortest line between the position and the center of the cavity may be at most about 30 degrees. The interior surface may have a second normal to the interior surface at a second position. The angle between the second normal and the shortest line between the position and the center of the cavity may be at most about 30 degrees. The shortest distance between the first position and the second position may be at least about two (2) millimeters. The cavity may comprise an interior surface having a first normal to the interior surface at a first position. The angle between the first normal and the direction of the gravitational acceleration vector may be at most about 30 degrees at a spatial configuration of the requested three-dimensional object. The interior surface may comprise a second normal to the interior surface at a second position. The angle between the second normal and the direction of the gravitational acceleration vector may be at most about 30 degrees at a spatial configuration of the requested three-dimensional object. The platform may be stationary during the first printing in operation (ii) and/or during the second printing in operation (iii). The platform may be vertically translatable. The platform may not be rotatable (e.g., during the first printing in operation (ii) and/or during the second printing in operation (iii)). The platform may be rotatable. The rotated may be about a horizontal axis. The first printing and/or second printing may be adjacent to a platform. The rotated may be about an axis that is parallel to the platform. The rotated may be about an axis different from a vertical axis. The rotated may be about an axis that is not perpendicular to the platform. Adjacent may be above. The segment may comprise a protrusion. The rotated modified three-dimensional object may be at least in part manually rotated. The rotated modified three-dimensional object may be at least in part automatically rotated. The at least one controller may be operatively coupled to the modified three-dimensional object. The at least one controller may be programmed to direct rotating the modified three-dimensional object after operation (ii). The system may further comprise a first energy source that is configured to generate a first energy beam that transforms a pre-transformed material to form at least a portion of the modified three-dimensional object and a second energy source that is configured to generate a second energy beam that transforms a pre-transformed material to form at least a portion of the segment of the three-dimensional object. The first energy source and the second energy source may be the same energy source. The first energy beam and the second energy beam may have the same characteristic. The first energy beam and the second energy beam differ by a least one energy beam characteristic. The energy beam characteristic may comprise a velocity, cross section, power density, fluence, duty cycle, dwell time, focus, or delay time, wherein the duty cycle comprises a dwell time or a delay time. The at least one controller can be programmed to direct the first energy beam to transform at least a portion of the pre-transformed material to form at least a portion of the modified three-dimensional object. The at least one controller can be programmed to direct the second energy beam to transform at least a portion of the pre-transformed material to form at least a portion of the segment of the three-dimensional object. The system may further comprise a metrological detector that is configured to facilitate alignment of a position of the modified three-dimensional object that has been rotated prior to directing the second printing operation (iii). The at least one controller may be operatively coupled to the metrological detector. The at least one controller may be programmed to direct alignment of the second printing according to the modified three-dimensional object (e.g., that has been rotated). The alignment may be with respect to the horizontal plane and/or vertical plane. The alignment may be with respect to a plane parallel to: (1) the platform and/or (2) normal to the gravitational vector. The alignment may be with respect to a plane perpendicular to: (1) the platform and/or (2) normal to the gravitational vector. The metrological detector may comprise a height mapper. The alignment may comprise identification of at least one position of the modified three-dimensional object and/or of the segment. The alignment may comprise (e.g., after operation (ii), and/or prior to operation (iii)), identification of a position of the modified three-dimensional object that has been rotated. The position may comprise an X, Y, or Z spatial position. Identifying the position may comprise image processing (e.g., using at least one optical sensor and/or detector). Identifying the position may comprise using a metrological detector (e.g., height mapper).

In another aspect, an apparatus for three-dimensional printing of at least one three-dimensional object comprising at least one controller that is programmed to perform the following operations: operation (a) modify a first model of a requested three-dimensional object to form (i) a second model that comprises a redacted segment from the requested three-dimensional object, and (ii) a third model that comprises the redacted segment; operation (b) print a modified three-dimensional object above a platform according to the second model, which printing comprises a first three-dimensional printing methodology; and operation (c) print the redacted segment according to the third model by using a second three-dimensional printing methodology, which printing comprises attaching the redacted segment to the modified three-dimensional object that has been rotated, to form the requested three-dimensional object.

At least two of operation (a), operation (b), and operation (c) may be directed by the same controller. The at least one controller may be a plurality of controllers. At least two of operation (a), operation (b), and operation (c) may be directed by different controllers. The at least one controller may be operatively coupled to the modified three-dimensional object. The at least one controller may be programmed to direct rotating the modified three-dimensional object after operation (ii).

In another aspect, a computer software product for three-dimensional printing of at least one three-dimensional object, comprising a non-transitory computer-readable medium in which program instructions are stored, which instructions, when read by a computer, cause the computer to perform operations comprising: operation (a) direct modifying a first model of a requested three-dimensional object to form (i) a second model that comprises a redacted segment from the requested three-dimensional object, and (ii) a third model that comprises the redacted segment; operation (b) direct printing a modified three-dimensional object above a platform according to the second model, which printing comprises a first three-dimensional printing methodology; and operation (d) direct printing the redacted segment according to the third model by using a second three-dimensional printing methodology, which printing comprises attaching the redacted segment to the modified three-dimensional object that has been rotated, to form the requested three-dimensional object.

At least two of operation (a), operation (b), operation (c), and operation (d) may be directed by the same controller. The at least one controller may be a plurality of controllers. At least two of operation (a), operation (b), operation (c), and operation (d) may be directed by different controllers. The computer software may comprise an operation to direct rotating the modified three-dimensional object relative to the platform. The operation of direct rotating may be after operation (b). The operation of direct rotating may be before operation (d).

In another aspect, an apparatus for printing one or more 3D objects comprises at least one controller that is programmed to direct a mechanism used in a three-dimensional printing methodology to implement (e.g., effectuate) the method disclosed herein, wherein the controller is operatively coupled to the mechanism. The controller may implement any of the methods disclosed herein.

In another aspect, an apparatus for printing one or more 3D objects comprises at least one controller that is programmed to implement (e.g., effectuate) the method disclosed herein. The controller may implement any of the methods disclosed herein.

In another aspect, a system for printing one or more 3D objects comprises an apparatus (e.g., used in a 3D printing methodology) and a controller that is programmed to direct operation of the apparatus, wherein the controller is operatively coupled to the apparatus. The apparatus may include any apparatus disclosed herein. The controller may implement any of the methods disclosed herein. The controller may direct any apparatus (or component thereof) disclosed herein.

In another aspect, a computer software product, comprising a non-transitory computer-readable medium in which program instructions are stored, which instructions, when read by a computer, cause the computer to direct a mechanism (e.g., used in the 3D printing) to implement (e.g., effectuate) any of the method disclosed herein, wherein the non-transitory computer-readable medium is operatively coupled to the mechanism. Wherein the mechanism comprises an apparatus or an apparatus component.

Another aspect of the present disclosure provides a non-transitory computer-readable medium comprising machine-executable code that, upon execution by one or more computer processors, implements any of the methods disclosed herein.

Another aspect of the present disclosure provides a non-transitory computer-readable medium comprising machine-executable code that, upon execution by one or more computer processors, effectuates directions of the controller(s) (e.g., as disclosed herein).

Another aspect of the present disclosure provides a computer system comprising one or more computer processors and a non-transitory computer-readable medium coupled thereto. The non-transitory computer-readable medium comprises machine-executable code that, upon execution by the one or more computer processors, (i) implements any of the methods disclosed herein and/or effectuates directions of the controller(s) disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGs.” herein), of which:

FIG. 1 shows a schematic side view of a three-dimensional (3D) printing system and apparatuses;

FIG. 2 schematically illustrates a 3D object;

FIGS. 3A-3D show schematic side views of 3D printing process;

FIG. 4 shows a schematic side view planes;

FIG. 5 shows a top view of a 3D object;

FIG. 6 shows a coordinate system;

FIGS. 7A-7C show various 3D objects and schemes thereof;

FIG. 8 shows a schematic of an optical setup;

FIG. 9 shows a schematic of a computer system;

FIG. 10 shows a schematic path;

FIG. 11 shows schematic paths; and

FIG. 12 schematically illustrates a cross section in portion of a 3D object.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an” and “the” are not intended to refer to only a singular entity, but include the general class of which a specific example may be used for illustration. The terminology herein is used to describe specific embodiments of the invention, but their usage does not delimit the invention. When ranges are mentioned, the ranges are meant to be inclusive, unless otherwise specified. For example, a range between value1 and value2 is meant to be inclusive and include value1 and value2. The inclusive range will span any value from about value1 to about value2. The term “between” as used herein is meant to be inclusive unless otherwise specified. For example, between X and Y is understood herein to mean from X to Y. The term “adjacent” or “adjacent to,” as used herein, includes ‘next to,’ ‘adjoining,’ ‘in contact with,’ and ‘in proximity to.’ In some instances, adjacent to may be ‘above’ or ‘below.’

The term “operatively coupled” or “operatively connected” refers to a first mechanism that is coupled (or connected) to a second mechanism to allow the intended operation of the second and/or first mechanism.

Three-dimensional printing (also “3D printing”) generally refers to a process for generating a 3D object. For example, 3D printing may refer to sequential addition of material layer or joining of material layers (or parts of material layers) to form a 3D structure, in a controlled manner. The controlled manner may include automated control. In the 3D printing process, the deposited material can be transformed (e.g., fused, sintered, melted, bound, or otherwise connected) to subsequently harden and form at least a part of the 3D object. Fusing (e.g., sintering or melting), binding, or otherwise connecting the material is collectively referred to herein as transforming the material (e.g., powder material). Fusing the material may include melting or sintering the material. Melting may comprise complete melting. In some embodiments, transforming may exclude sintering. Binding can comprise chemical bonding. Chemical bonding can comprise covalent bonding. Examples of 3D printing include additive printing (e.g., layer by layer printing, or additive manufacturing). 3D printing may include layered manufacturing. 3D printing may include rapid prototyping. 3D printing may include solid freeform fabrication. The 3D printing may further comprise subtractive printing.

3D printing methodologies can comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition.

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

The methods, apparatuses, software, and systems of the present disclosure can be used to form 3D objects for various uses and applications. Such uses and applications include, without limitation, electronics, components of electronics (e.g., casings), machines, parts of machines, tools, implants, prosthetics, fashion items, clothing, shoes, jewelry, or any combination thereof. The implants may be directed (e.g., integrated) to a hard, a soft tissue, or to a combination of hard and soft tissues. The implants may form adhesion with hard and/or soft tissue. The machines may include a motor or motor part. The machines may include a vehicle. The machines may comprise aerospace related machines. The machines may comprise airborne machines. The vehicle may include an airplane, drone, car, train, bicycle, boat, or shuttle (e.g., space shuttle). The machine may include a satellite or a missile. The uses and applications may include 3D objects relating to the industries and/or products listed herein.

The fundamental length scale (e.g., the diameter, spherical equivalent diameter, diameter of a bounding circle, or largest of height, width and length; abbreviated herein as “FLS”) of the printed 3D object or a portion thereof can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object or a portion thereof can be at most about 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m, 500 m, or 1000 m. The FLS of the printed 3D object or a portion thereof can any value between the afore-mentioned values (e.g., from about 50 μm to about 1000 m, from about 500 μm to about 100 m, from about 50 μm to about 50 cm, or from about 50 cm to about 1000 m). In some cases, the FLS of the printed 3D object or a portion thereof may be in between any of the afore-mentioned FLS values.

The present disclosure provides systems, apparatuses, software, and/or methods for 3D printing of a requested 3D object from a pre-transformed material (e.g., powder material). The object can be pre-ordered, pre-designed, pre-modeled, or designed in real time (i.e., during the process of 3D printing). The 3D printing method can be an additive method in which a first layer of the 3D object is printed, and thereafter a volume of a pre-transformed material is added to the first 3D object layer as separate sequential layer (or parts thereof). Each additional sequential layer (or part thereof) can be added to the previous layer by transforming (e.g., fusing (e.g., melting)) a fraction of the pre-transformed material to form a transformed material layer as part of the 3D object. The transformed material may be a hardened material. Alternatively, the transformed material may harden to form at least a portion of the (hard) 3D object. The hardening can be actively induced (e.g., by cooling) or can occur without intervention (e.g., naturally).

During the transforming operation, the pressure of the enclosure atmosphere (e.g., comprising at least one gas) may be an ambient pressure. During the transforming operation, the material bed may be (e.g., substantially) devoid of pressure gradients. For example, during the transforming operation, the material bed may be (e.g., substantially) at constant pressure (e.g., ambient pressure). During the formation of the 3D object (e.g., during the formation of the layer of hardened material or a portion thereof), a remainder of the material bed that did not transform, may be at an ambient temperature. During the formation of the 3D object (e.g., during the formation of the layer of hardened material or a portion thereof), a remainder of the material bed that did not transform, may not be heated (e.g., actively heated), for example, beyond an ambient temperature. During the formation of the 3D object (e.g., during the formation of the layer of hardened material or a portion thereof), a remainder of the material bed that did not transform, may be at a temperature of at most about 10 degrees Celsius (° C.), 20° C., 25° C., 30° C., 40° C., 50° C., 60° C., 70° C., 80° C., 90° C., 100° C., 150° C., 200° C., 250° C., 300° C., 350° C., 400° C., 450° C., 500° C., 550° C., 600° C., 650° C., 700° C., 750° C., 800° C., 850° C., 900° C., or 1000° C. During the formation of the 3D object (e.g., during the formation of the layer of hardened material or a portion thereof), a remainder of the material bed that did not transform, may be at a temperature between any of the above-mentioned temperature values (e.g., from about 10° C. to about 1000° C., from about 10° C. to about 400° C., from about 100° C. to about 600° C., from about 200° C. to about 500° C., or from about 300° C. to about 450° C.).

In some embodiments, the 3D object is formed in a material bed. The FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m or 5 m. The FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m or 5 m. The FLS of the material bed can be between any of the afore-mentioned values (e.g., from about 50 mm to about 5 m, from about 250 mm to about 500 mm, from about 280 mm to about 1 m, or from about 500 mm to about 5 m).

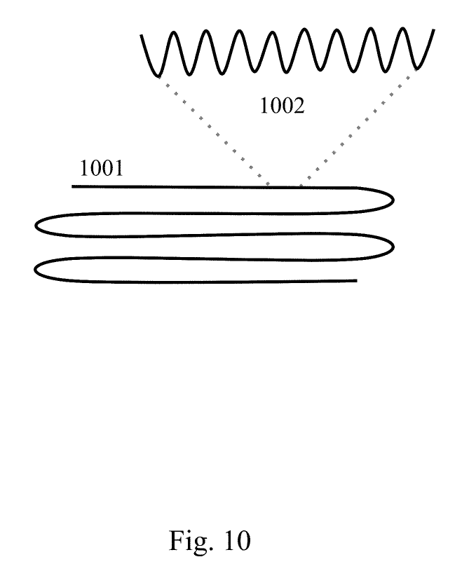

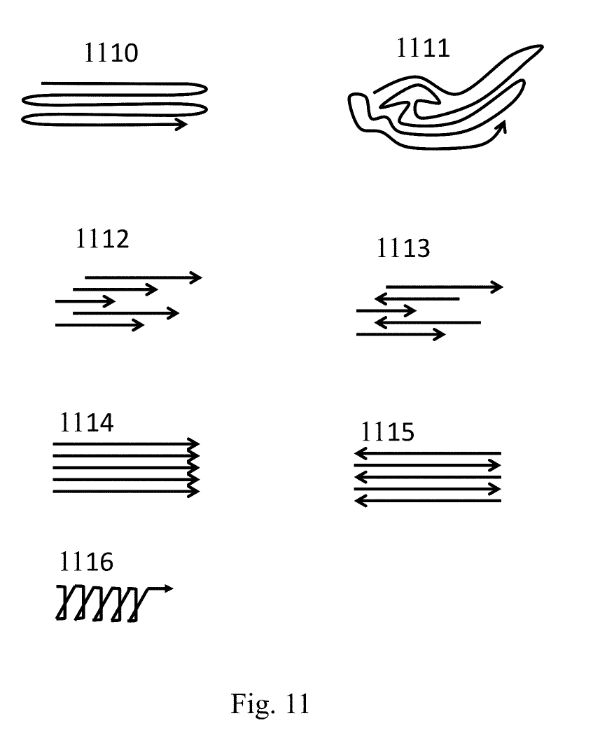

The 3D object may be generated by providing a first layer of pre-transformed material (e.g., powder) in an enclosure; transforming at least a portion of the pre-transformed material in the first layer to form a transformed material. The transforming may be effectuated (e.g. conducted) with the aid of an energy beam. The energy beam may travel along a path (e.g., FIG. 10, or FIG. 11). The path may comprise hatching. The path may comprise tiles. The tiles may be formed by a step and repeat sequence along the path. The path may comprise a vector or a raster path. The method may further comprise hardening the transformed material to form a hardened material as part of the 3D object. In some embodiments, the transformed material may be the hard material as part of the 3D object. The method may further comprise providing a second layer of pre-transformed material adjacent to (e.g., above) the first layer and repeating the transformation process delineated above.

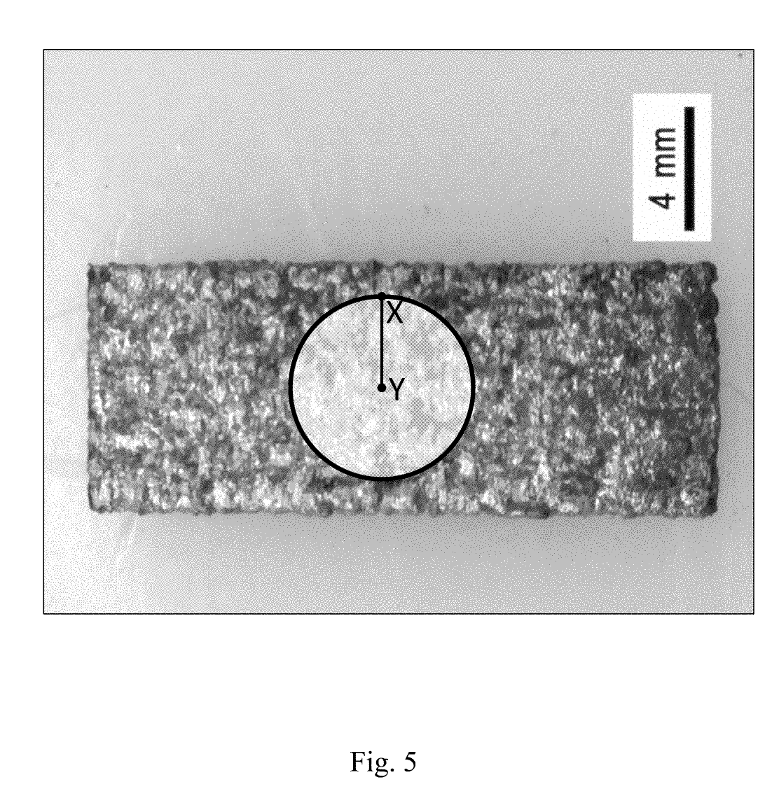

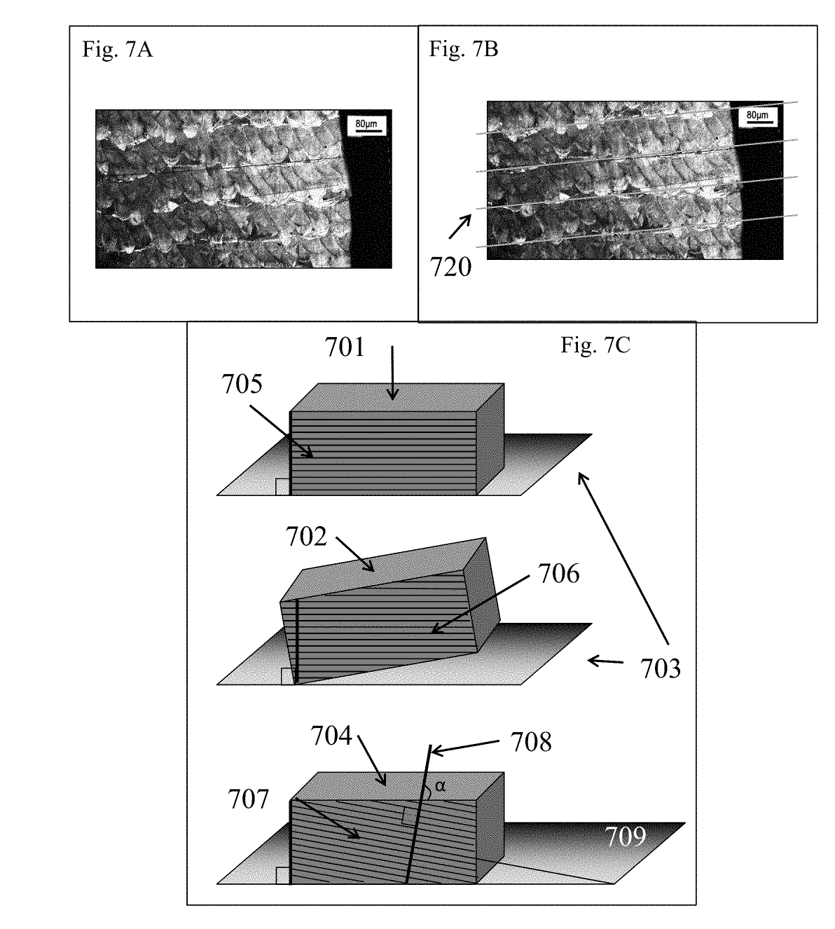

In some embodiments, the 3D object is an extensive 3D object. The 3D object can be a large 3D object. The 3D object may comprise a large hanging structure (e.g., wire, ledge, or shelf). Large may be a 3D object having a fundamental length scale of at least about 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. In some instances, The fundamental length scale (e.g., the diameter, spherical equivalent diameter, diameter of a bounding circle, or largest of height, width and length; abbreviated herein as “FLS”) of the printed 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m, 500 m, or 800 m. The FLS of the printed 3D object can be at most about 1000 m, 500 m, 100 m, 80 m, 50 m, 10 m, 5 m, 4 m, 3 m, 2 m, 1 m, 90 cm, 80 cm, 60 cm, 50 cm, 40 cm, 30 cm, 20 cm, 10 cm, or 5 cm. In some cases, the FLS of the printed 3D object may be between any of the afore-mentioned FLSs (e.g., from about 50 μm to about 1000 m, from about 120 μm to about 1000 m, from about 120 μm to about 10 m, from about 200 μm to about 1 m, from about 1 cm to about 100 m, from about 1 cm to about 1 m, from about 1 m to about 100 m, or from about 150 μm to about 10 m). The FLS (e.g., horizontal FLS) of the layer of hardened material may have any value listed herein for the FLS of the 3D object. The example in FIG. 7C shows a top (e.g., horizontal) portion 701 of the layer of hardened material (e.g., the top layer in the 7C scheme). The example in FIG. 5 shows a top view of the layer of hardened material, which is a horizontal portion of the layer of hardened material.

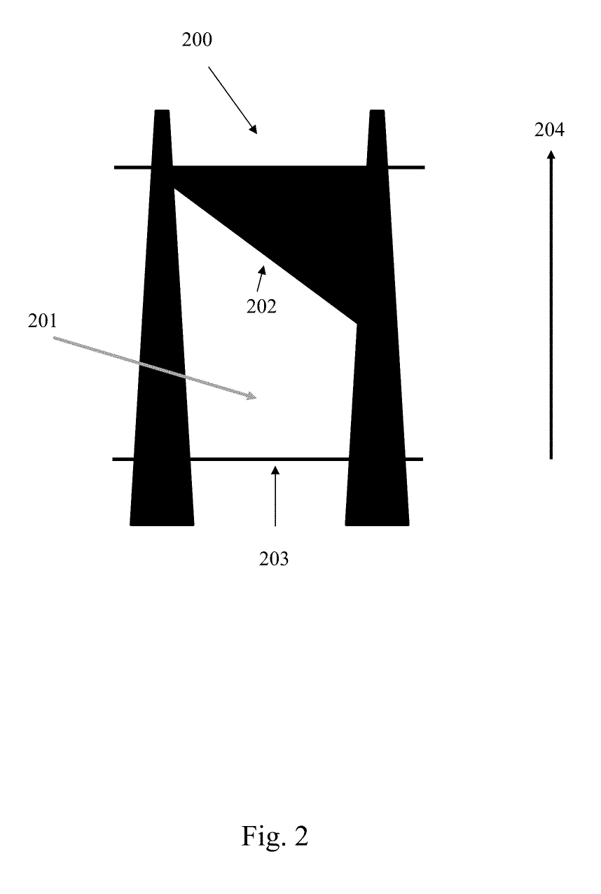

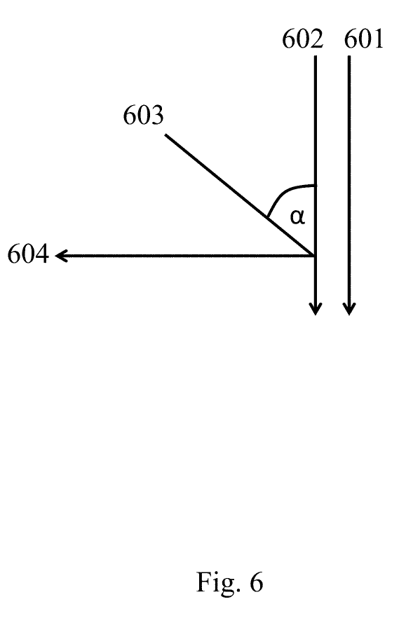

In some embodiments, the methods, systems, apparatuses, and/or software effectuate the formation of at least one complex 3D object comprising one or more enlarged cavities. These 3D objects may have at least one substantially planar or nearly planar face. Substantially planar may be a face having a large radius of curvature. FIG. 2 shows a side view of a desired 3D object having a cavity 201, a planar face 203 that is a hanging structure, an angular portion 202, a top portion 200 (e.g., of the cavity), a bottom portion 203 with respect to its natural and/or desired orientation. The angular portion may have any value of the acute angle alpha (e.g., FIG. 6, between lines 602 and 603). The natural and/or desired orientation can be relative to the direction of the gravitational field (e.g., 601). The natural and/or desired orientation is depicted in 204. Some complex 3D objects may require a specific (e.g., preferred) print orientation according to which the printing should progress (e.g., due to material strength constraints). For example, the desired 3D object may comprise a desired axis along which the printing should ideally progress. In the example of the 3D object in FIG. 2, the natural orientation is depicted as a side view or a vertical cross section, with respect to the direction of the gravitational field. A model of the desired 3D object may be aligned according to this specific orientation. Subsequent thereto, the model of the 3D object may exhibit a substantially planar (e.g., flat) or nearly planar surfaces in both the top (e.g., 200) and bottom (e.g., 203) of the 3D object. The printing process of such structures (e.g., 3D object comprising a cavity) may be challenging and require support structures (e.g., within the cavity) which are difficult and/or impossible to remove. At times, the 3D object may comprise, additionally or alternatively, one or more embossed surface. At times, the 3D object may comprise, additionally or alternatively, one or more hanging structures (e.g., at least one overhang). At least one embossed surface may comprise a hanging surface (e.g., a ledge or a shelf). At least one of the embossed surfaces may comprise an angular portion of the 3D object. The present disclosure delineates methods, systems, apparatuses and/or software that effectuate the generation of such 3D objects. The 3D object (or at least one cross section thereof) may be symmetric or asymmetric. The cavity (or at least one cross section thereof) may be symmetric or asymmetric. Sometimes it may be difficult to remove the supports from the embossed and/or overhanging surfaces by conventional 3D printing methodologies. Sometimes it may be difficult to remove the supports from the cavity by conventional 3D printing methodologies. FIG. 2 shows an example of a top embossed surface 200 and a bottom embossed surface 203.

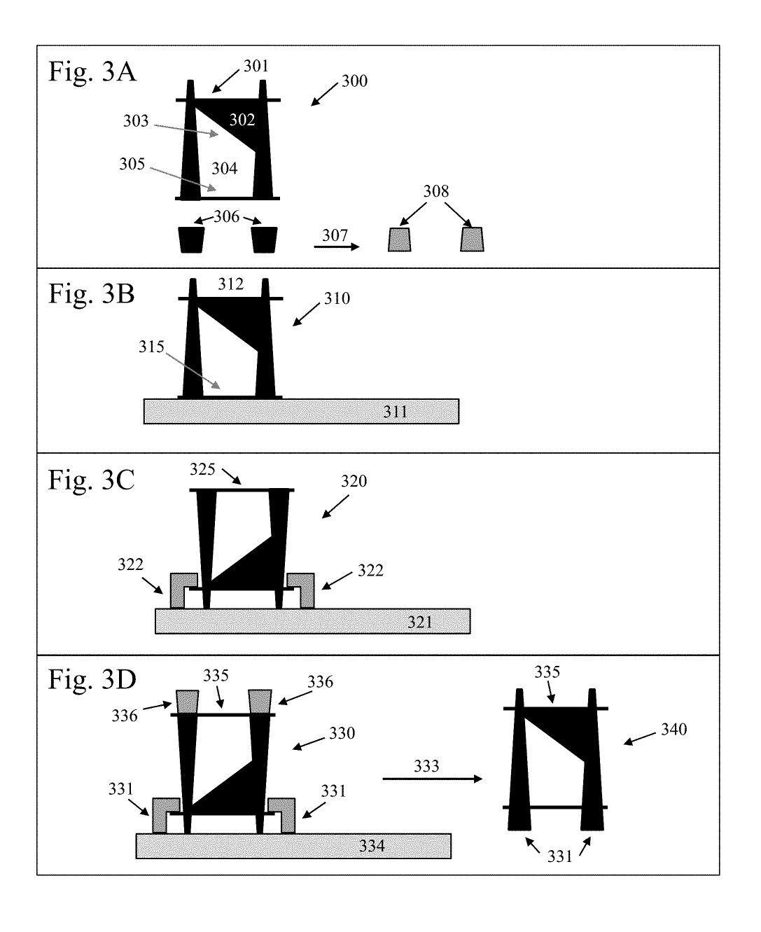

In an aspect, a method of forming the 3D object having the cavity and the one or more embossed surfaces, may be to divide the 3D printing sequence of the requested 3D object into a multiplicity of 3D printing and manufacturing operations termed herein “Pre-print 1” and “Pre-print 2”. The Pre-print 1 operation may comprise: modifying a (e.g., virtual) model of the requested 3D object to a second (e.g., virtual) model of a segment (e.g., redacted embossed portion) and a first (e.g., virtual) model of a modified 3D object. The modified 3D object model may comprise a hanging 3D plane (e.g., planar object). The modified 3D object model may be used to generate a first set of 3D printing instructions that direct materialization of the first model of the modified 3D object into a modified 3D object using a first 3D printing methodology. FIG. 3A shows an example of a modification of the desired 3D object of FIG. 2 that includes a modification thereof, which modification comprises removing a segment (e.g., the embossed portion 306) from the model of the requested 3D object to generate a first set of 3D printing instruction for printing the modified 3D object that includes a portion of the requested 3D object (e.g., FIG. 2, 300), and a second set of 3D printing instructions for printing the segment. The second set of 3D printing instructions can be aligned with the first set of 3D printing instructions to materialize the requested 3D object. The hanging ledge (e.g., 305) can be (e.g., substantially) planar, or nearly planar. Nearly planar comprises deviating from an average or mean planar surface by at most about 15°, 10°, 5°, 2°, 1°, or 0.5°. Nearly planar comprises deviating from an average or mean planar surface by any value between the afore-mentioned values (e.g., from about 15° to about 0.5°, from about 15° to about 10°, from about 10° to about 0.5°, or from about 5° to about 0.5°). Methods for generating a 3D plane (e.g., planar object) having an enlarged cavity (e.g., 304), top embossed structure (e.g., 301), hanging 3D object with diminished supports (e.g., 3D plane, 305), and/or an angular portion (e.g., 302) are delineated in Patent Application serial number PCT/US15/36802, titled “APPARATUSES, SYSTEMS AND METHODS FOR THREE-DIMENSIONAL PRINTING” that was filed on Jun. 19, 2015; or in Provisional Patent Application Ser. No. 62/307,254 that was filed on Mar. 11, 2016, titled “SYSTEMS, APPARATUS AND METHODS FORMING A SUSPENDED OBJECT;” in Patent Application serial number PCT/US16/034454, titled “THREE-DIMENSIONAL OBJECTS FORMED BY THREE-DIMENSIONAL PRINTING” that was filed on May 26, 2016; in Provisional Patent application Ser. No. 62/265,817, filed on Dec. 10, 2015, titled “APPARATUSES, SYSTEMS AND METHODS FOR EFFICIENT THREE DIMENSIONAL PRINTING,” in Provisional Patent Application Ser. No. 62/317,070 that was filed on Apr. 1, 2016, titled “APPARATUSES, SYSTEMS AND METHODS FOR EFFICIENT THREE-DIMENSIONAL PRINTING,” in patent application Ser. No. 15/374,535, titled “SKILLFUL THREE-DIMENSIONAL PRINTING” that was filed on Dec. 9, 2016; in Patent Application serial number PCT/US16/66000, titled “SKILLFUL THREE-DIMENSIONAL PRINTING,” that was filed on Dec. 9, 2016; in Provisional Patent Application Ser. No. 62/320,334 that was filed on Apr. 8, 2016, titled “METHODS, SYSTEMS, APPARATUSES, AND SOFTWARE FOR ACCURATE THREE-DIMENSIONAL PRINTING,” in Patent Application serial number PCT/US17/18191, that was filed on Feb. 16, 2017, titled “ACCURATE THREE-DIMENSIONAL PRINTING”; in patent application Ser. No. 15/435,078, that was filed on Feb. 16, 2017, titled “ACCURATE THREE-DIMENSIONAL PRINTING”; or in Patent Application serial number EP17156707.6, that was filed on Feb. 17, 2017, titled “ACCURATE THREE-DIMENSIONAL PRINTING,” all of which are incorporated herein by reference in their entirety. In some embodiments, the cavity (e.g., 304) is substantial. For example, the cavity can occupy at least about 20%, 30%, 40%, 50%, 60%, 70%, 80%, or 90% of the volume of the 3D object (percentages calculated volume per volume). The cavity can occupy any volume per volume percentage value between the above-mentioned percentage values, relative to the volume of the 3D object (e.g., from about 20% to about 90%, from about 40% to about 90%, or from about 60% to about 90%). The modified 3D object (e.g., 310) may be printed such that it is attached to the platform (e.g., building platform, base, and/or substrate). FIG. 3B shows an example of a side view of the modified 3D object 310 that is printed with its hanging planar portion 315 attached to the platform 311, and situated at its natural and/or desired orientation (e.g., FIG. 2, 204). The Pre-print 2 operation may comprise (a) removing (e.g., detaching) the modified 3D object (e.g., 310) from the material bed (e.g., and from the platform, e.g., 311); (b) rotating the modified 3D object at an angle (e.g., 180°) relative to the platform (e.g., 311) to form a rotated modified object (e.g., 320); (c) optionally adjusting the relative position of the energy beam to the platform (and/or to the material bed. And optionally depositing at least one layer of pre-transformed material); and (d) forming the segment (e.g., the redacted embossed portion, e.g., 336) according to the second model of the segment (e.g., redacted embossed portion), by using a second 3D printing methodology, which segment is aligned with the rotated modified 3D object to form the requested 3D object (e.g., 340). Adjusting the relative position in operation (c) may comprise using a metrological detector (e.g., height mapper) that is configured to facilitate identification of at least one position of the modified 3D object (e.g., that has been rotated) and/or alignment of a position of the energy beam and/or of the printing instructions with respect to the identified position. Adjusting the relative position in operation (c) may comprise using a metrological detector (e.g., height mapper) that is configured to facilitate identification of at least one position of the modified 3D object (e.g., that has been rotated) and/or alignment of a trajectory and/or footprint of the energy beam with respect to the identified position. The alignment of the energy beam trajectory and/or footprint may facilitate alignment of the modified 3D object with the segment to form the requested. The identification of the at least one position of the modified 3D object may facilitate adjusting the 3D printing instructions to facilitate alignment of the printed segment with the rotated modified 3D object to form the requested 3D object. The alignment may comprise identifying the horizontal and/or vertical position of the modified 3D object that has been rotated. The alignment may be with respect to the horizontal plane and/or vertical plane. The alignment may be with respect to a plane parallel and/or perpendicular to the platform and/or to the gravitational vector. The alignment may be with respect to a plane parallel to: (1) the platform and/or (2) normal to the gravitational vector. The alignment may be with respect to a plane perpendicular to: (1) the platform and/or (2) normal to the gravitational vector. The alignment may comprise identification of at least one position of the modified 3D object and/or of the segment. The alignment may comprise (e.g., after printing the modified 3D object, and/or prior to printing the segment), identifying at least one position of the modified three-dimensional object that has been rotated. Identifying the at least one position may comprise identifying at least one (e.g., X, Y and/or Z) coordinate of the modified 3D object. The coordinate may be identified relative to the platform, or relative to another (e.g., stationary) position. The stationary position may be of the 3D printer. The at least one position of the modified 3D object may comprise an X, Y, or Z spatial position (e.g., position in space). Identifying the position may comprise image processing. Identifying the position may comprise using at least one optical sensor and/or detector. Identifying the position may comprise using a metrological detector (e.g., height mapper). The metrological detector may comprise a height mapper. The height mapper may be any height mapper disclosed in Patent Applications having serial numbers PCT/US17/18191, 15/435,078, or EP17156707.6; or in Provisional Patent Application having Ser. No. 62/320,334; all of which are incorporated herein by reference in their entirety. The second model of the segment (e.g., redacted embossed portion) may be rotated by a respective angle (e.g., respective to the rotation of the modified model of the 3D object). The second model may be used to generate 3D printing instructions that will materialized the segment (e.g., redacted embossed portion) by using the second 3D printing methodology. The second 3D printing methodology can be the same or different than the first 3D printing methodology. FIG. 3D shows an example of forming the segment (e.g., redacted embossed portion 336) on the modified 3D object 330. FIG. 3A shows an example where the segment (e.g., redacted embossed portion 306) is rotated 307 to result in the rotated segment (e.g., redacted embossed portion) 308 (e.g., by 180°). The rotation may facilitate printing a 3D object portion with a reduced number (e.g., absence) of auxiliary supports. The rotation may facilitate printing a 3D object portion with auxiliary supports that are (e.g., easily) removable, for example, without (e.g., substantially) harming the printed 3D object portion. For example, the rotation may comprise a rotation that may allow the previously top surface (e.g., to be placed adjacent to the platform). Adjacent may be on the platform. The rotation may be about a horizontal axis. The rotation may be about an axis that is not vertical. FIG. 3C shows an example of a 180° rotation of the generated modified 3D object 310 into a rotated modified 3D object 320, wherein the previously top surface 312 is disposed adjacent to the platform 321. In the example of FIG. 3C, the bottom portion 315 is now disposed farthest from the platform 321 and is depicted as 325. The rotated modified 3D object may be aligned and held at the platform (e.g., by one or more fasteners, e.g., clips 322). Alternatively, or additionally, the scanner (e.g., of the platform and/or of the energy beam) may align itself to the location of the rotated modified 3D object. The removal of the auxiliary support (e.g., platform) from the modified 3D object may comprise trimming, machining or etching (e.g., laser etching). The machining may comprise electrical discharge machining (abbreviated herein as “EDM”). The machine may comprise using a saw (e.g., planar saw) and/or an energy beam (e.g., laser). The EDM may comprise Sinker or wire EDM. The formed 3D object can be later rotated to its natural, requested, and/or desired location (e.g., 340), such that the portion that is desired to be on top (e.g., 335), will be on top (e.g., relative to the gravitational field); and the portion that is desired to be at the bottom (e.g., 331), will be at the bottom (e.g., relative to the gravitational field). Prior to rotating the formed 3D object (e.g., 330) comprising the segment (e.g., redacted embossed portion,e.g., 336), any fasteners (if used, e.g., 331) may be removed. The rotation (e.g., during/after/before the “Pre-print 1” and/or “Pre-print 2”) can be of a certain rotation angle (e.g., alpha) with respect to a normal (e.g., FIG. 6, 602) to the platform (e.g., 604), and/or with respect to the gravitational center vector (e.g., 601). The acute rotation angle can be at least about 1°, 2°, 5°, 10°, 15°, 20°, 25°, 30°, 35°, 40°, 45°, 50°, 55°, 60°, 65°, 70°, 75°, 80°, 85°, or 89° with respect to a normal to the platform, and/or with respect to the gravitational center vector. The acute rotation angle can be at most about 2°, 5°, 10°, 15°, 20°, 25°, 30°, 35°, 40°, 45°, 50°, 55°, 60°, 65°, 70°, 75°, 80°, 85°, or 90° with respect to a normal to the platform, and/or with respect to the gravitational center vector. The rotation angle can be an angle from the above-mentioned values, for example, about 1° to about 90°, from about 30° to about 90°, from about 1° to about 45°, from about 45° to about 90°, from about 35° to about 90°, from about 25° to about 90°, from about 10° to about 90°, or from about 5° to about 90° with respect to a normal to the platform, and/or with respect to the gravitational center vector. The value of the rotational angle can be any value of the angle alpha disclosed herein. FIG. 6 shows an example of a coordinate system that can be used to represent various examples. In an example: line 604 represents a platform above which the 3D object is disposed; line 603 represents the axis of rotation relative to which the 3D object is rotated; line 602 represent a normal to the platform and gravitational field; and line 601 represents the direction of the gravitational field.

The hanging portion (e.g., FIG. 2, 203) may be a plane like structure (referred to herein as “three-dimensional plane,” or “3D plane”). The 3D plane may have a relatively small width as opposed to a relatively large surface area. For example, the 3D plane may have a small height relative to a large horizontal plane. The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf.

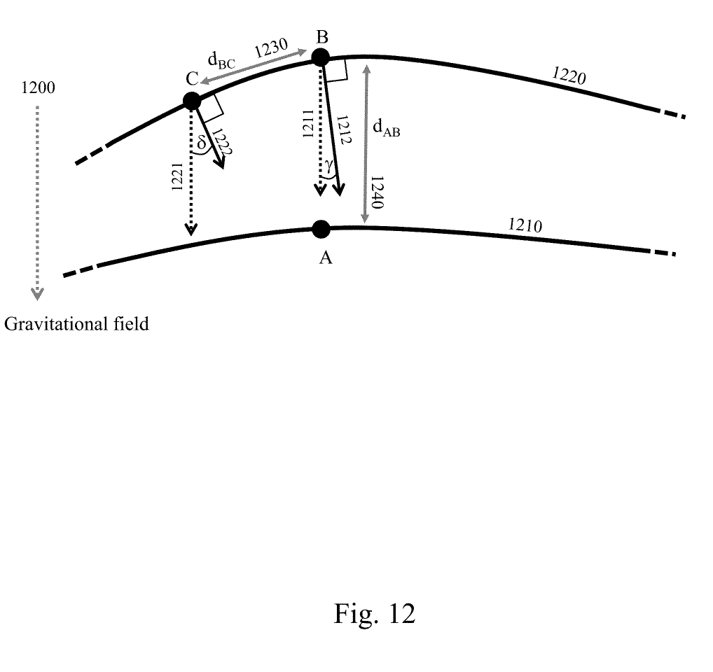

In some embodiments, the 3D object comprises a first portion and a second portion. The first portion may be connected to a rigid-portion (e.g., core) at one, two, or three sides (e.g., as viewed from the top). The rigid-portion may be the rest of the 3D object. The second portion may be connected to the rigid-portion at one, two, or three sides (e.g., as viewed from the top). For example, the first and second portion may be connected to a rigid-portion (e.g., column, post, or wall) of the 3D object. For example, the first and second portion may be connected to an external cover that is a part of the 3D object. The first and/or second portion may be a wire or a 3D plane. The first and/or second portion may be different from a wire or 3D plane. The first and/or second portion may be a blade (e.g., turbine or impeller blade). The first and second portions may be (e.g., substantially) identical in terms of structure, geometry, volume, and/or material composition. The first and second portions may be (e.g., substantially) identical in terms of structure, geometry, volume, material composition, or any combination thereof. The first portion may comprise a top surface. Top may be in the direction away from the platform and/or opposite to the gravitational field. The second portion may comprise a bottom surface (e.g., bottom skin surface). Bottom may be in the direction towards the platform and/or in the direction of the gravitational field. FIG. 12 shows an example of a first (e.g., top) surface 1210 and a second (e.g., bottom) surface 1220. At least a portion of the first and second surface are separated by a gap. At least a portion of the first surface is separated by at least a portion of the second surface (e.g., to constitute a gap). The gap may be filled with pre-transformed or transformed (e.g., and subsequently hardened) material during the formation of the 3D object. In some examples, the gap is filled with at least one gas (e.g., during and/or after the 3D printing). The second surface may be a bottom skin layer. FIG. 12 shows an example of a vertical gap distance 1240 that separates the first surface 1210 from the second surface 1220. The vertical gap distance may be equal to the distance disclosed herein between two adjacent 3D planes. The vertical gap distance may be equal to the vertical distance of the gap as disclosed herein. Point A (e.g., in FIG. 12) may reside on the top surface of the first portion. Point B may reside on the bottom surface of the second portion. The second portion may be a cavity ceiling or hanging structure as part of the 3D object. Point B (e.g., in FIG. 12) may reside above point A. The gap value may reflect the (e.g., shortest) distance (e.g., vertical distance) between points A and B. FIG. 12 shows an example of the gap 1240 that constitutes the shortest distance d_{AB} between points A and B. There may be a first normal to the bottom surface of the second portion at point B. FIG. 12 shows an example of a first normal 1212 to the surface 1220 at point B. The angle between the first normal 1212 and a direction of the gravitational acceleration vector 1200 (e.g., direction of the gravitational field) may be any angle γ. Point C may reside on the bottom surface of the second portion. There may be a second normal to the bottom surface of the second portion at point C. FIG. 12 shows an example of the second normal 1222 to the surface 1220 at point C. The angle between the second normal 1222 and the direction of the gravitational acceleration vector 1200 may be any angle δ. Vectors 1211, and 1221 are parallel to the gravitational acceleration vector 1200. The angles γ and δ may be the same or different. The angle between the first normal 1212 and/or the second normal 1222 to the direction of the gravitational acceleration vector 1200 may have the value of any angle alpha disclosed herein. The angle between the first normal 1212 and/or the second normal 1222 with respect to the normal to the substrate may have the value of any angle alpha. The angles γ and δ may have the value of any angle alpha disclosed herein. For example, alpha may be at most about 45°, 40°, 30°, 20°, 10°, 5°, 3°, 2°, 1°, or 0.5°. The shortest distance between points B and C may be any value of the auxiliary support feature spacing distance mentioned herein. For example, the shortest distance BC (e.g., d_{BC}) may be at least about 0.1 millimeters (mm), 0.5 mm, 1 mm, 1.5 mm, 2 mm, 3 mm, 4 mm, 5 mm, 10 mm, 15 mm, 20 mm, 25 mm, 30 mm 35 mm, 40 mm, 50 mm, 100 mm, 200 mm, 300 mm, 400 mm, or 500 mm. As another example, the shortest distance BC may be at most about 500 mm, 400 mm, 300 mm, 200 mm, 100 mm, 50 mm, 40 mm, 35 mm, 30 mm, 25 mm, 20 mm, 15 mm, 10 mm, 5 mm, 4 mm, 3 mm, 2 mm, 1.5 mm, 1 mm, 0.5 mm, or 0.1 mm. FIG. 12 shows an example of the shortest distance BC (e.g., 1230, dBc). The bottom skin layer may be the first surface and/or the second surface. The bottom skin layer may be the first formed layer of the 3D object. The bottom skin layer may be the first formed hanging layer in the 3D object (e.g., that is separated by a gap from a previously formed layer of the 3D object). The vertical gap distance may be at least about 30 μm, 35 μm, 40 μm, 50 μm, 60 μm, 70 μm, 80 μm, 90 μm, 100 μm, 150 μm, or 200 μm. The gap size may be any value between the afore-mentioned values (e.g., from about 30 μm to about 200 μm, from about 100 μm to about 200 μm, from about 30 μm to about 100 mm, from about 80 mm to about 150 mm). The vertical distance of the gap may be at least about 0.05 mm, 0.1 mm, 0.25 mm, 0.5 mm, 1 mm, 2 mm, 3 mm, 4 mm, 5 mm, 6 mm, 7 mm, 8 mm, 9 mm, or 10 mm. The vertical distance of the gap may be at most about 0.05 mm, 0.1 mm, 0.25 mm, 0.5 mm, 1 mm, 2 mm, 3 mm, 4 mm, 5 mm, 6 mm, 7 mm, 8 mm, 9 mm, 10 mm, or 20 mm. The vertical distance of the gap may be any value between the afore-mentioned values (e.g., from about 0.05 mm to about 20 mm, from about 0.05 mm to about 0.5 mm, from about 0.2 mm to about 3 mm, from about 0.1 mm to about 10 mm, or from about 3 mm to about 20 mm).

In some embodiments, the rotation scheme (e.g., in Pre-print 1 and Pre-print 2) is repeated multiple times. The angle of rotation in each rotation scheme may be (e.g., substantially) the same or different. The first material bed and the second material bed may comprise (e.g., substantially) the same or different materials. The For example, the material beds may comprise the same type of material. The different material beds may differ in at least one material characteristic. The material characteristic may be comprising material type, physical phase, crystal structure, microstructure, metallurgical phase, or FLS of particles (when applicable). The layer of pre-transformed material that is deposited in a material bed may comprise the same, or different material, as the previously deposited layer of pre-transformed material. The 3D object may comprise at least two layers of hardened material having different material types. The 3D object may comprise at least two layers of hardened material having (e.g., substantially) the same material types. The (e.g., substantially) same material types may have different metallurgical and/or crystal structures. The 3D object may comprise at least two layers of hardened material having (e.g., substantially) the same material types, and having (e.g., substantially) the same metallurgical and/or crystal structures.

The material (e.g., pre-transformed material, transformed material, or hardened material) may comprise elemental metal, metal alloy, ceramics, an allotrope of elemental carbon, a polymer, or a resin. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball or a carbon nanotube. The ceramic material may comprise cement. The ceramic material may comprise alumina. The material may comprise sand, glass, or stone. In some embodiments, the material may comprise an organic material, for example, a polymer or a resin. The organic material may comprise a hydrocarbon. The polymer may comprise styrene. The organic material may comprise carbon and hydrogen atoms, carbon and oxygen atoms, carbon and nitrogen atoms, carbon and sulfur atoms, or any combination thereof. In some embodiments, the material may exclude an organic material (e.g., polymer). The polymer may be plastic, polyurethane, or wax. The polymer may be a resin. The material may comprise a solid or a liquid. In some embodiments, the material may comprise a silicon-based material, for example, silicon based polymer or a resin. The material may comprise an organosilicon-based material. The material may comprise silicon and hydrogen atoms, silicon and carbon atoms, or any combination thereof. In some embodiments, the material may exclude a silicon-based material. The solid material may comprise powder material. The powder material may be coated by a coating (e.g., organic coating such as the organic material (e.g., plastic coating)). The material may be devoid of organic material. In some examples, the material may not be coated by organic and/or silicon based materials. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) or wires.

Pre-transformed material as understood herein is a material before it has been transformed by an energy beam and/or flux during the 3D printing process. The pre-transformed material may be a material that was, or was not, transformed prior to its use in the 3D printing process. The pre-transformed material may comprise a gas, a liquid a semi-solid (e.g., gel) or a solid. The pre-transformed material may comprise a particulate material. The particulate material may comprise a powder. The powder may comprise solid particles. The particulate material may comprise vesicles. The vesicles may comprise a gas, a liquid, a semi-solid, or a solid material.

The material may comprise a powder material. The material may comprise a solid material. The material may comprise one or more particles or clusters. The term “powder,” as used herein, generally refers to a solid having fine particles. The powder may also be referred to as “particulate material.” Powders may be granular materials. The powder particles may comprise micro particles. The powder particles may comprise nanoparticles. In some examples, a powder comprising particles having an average fundamental length scale (e.g., the diameter, spherical equivalent diameter, diameter of a bounding circle, or the largest of height, width and length; herein designated as “FLS”) of at least about 5 nanometers (nm), 10 nm, 20 nm, 30 nm, 40 nm, 50 nm, 100 nm, 200 nm, 300 nm, 400 nm, 500 nm, 1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. The particles comprising the powder may have an average fundamental length scale of at most about 100 μm, 80 μm, 75 μm, 70 μm, 65 μm, 60 μm, 55 μm, 50 μm, 45 μm, 40 μm, 35 μm, 30 μm, 25 μm, 20 μm, 15 μm, 10 μm, 5 μm, 1 μm, 500 nm, 400 nm, 300 nm, 200 nm, 100 nm, 50 nm, 40 nm, 30 nm, 20 nm, 10 nm, or 5 nm. In some cases, the powder may have an average fundamental length scale between any of the values of the average particle fundamental length scale listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm). The material bed may comprise the powder material. The powder material may comprise a pre-transformed (e.g., powder) material that remains flowable throughout the 3D printing process (e.g., and at ambient temperature and/or pressure).

The powder can be composed of individual particles. The individual particles can be spherical, oval, prismatic, cubic, wires, or irregularly shaped. The particles can have a FLS. The powder can be composed of a homogenously shaped particle mixture such that all the particles have substantially the same shape and FLS magnitude within at most 1%, 5%, 8%, 10%, 15%, 20%, 25%, 30%, 35%, 40%, 50%, 60%, or 70%, distribution of FLS. In some cases, the powder can be a heterogeneous mixture such that the particles have variable shape and/or FLS magnitude.

At least parts of the layer can be transformed to a transformed material (e.g., using at least one energy beam) that may (e.g., subsequently) form at least a fraction (also used herein “a portion,” or “a part”) of a harden (e.g., solid) 3D object. At times a layer of transformed or hardened (e.g., hard) material may comprise a cross section of a 3D object (e.g., a horizontal cross section). The layer may correspond to a cross section of a desired 3D object (e.g., a model). At times a layer of transformed or hardened (e.g., hard) material may comprise a deviation from a cross section of a model of a 3D object. The deviation may include vertical or horizontal deviation. A pre-transformed material may be a powder material. A pre-transformed material layer (or a potion thereof) can have a thickness (e.g., layer height) of at least about 0.1 micrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A pre-transformed material layer (or a potion thereof) can have a thickness of at most about 1000 μm, 900 μm, 800 μm, 700 μm, 60 μm, 500 μm, 450 μm, 400 μm, 350 μm, 300 μm, 250 μm, 200 μm, 150 μm, 100 μm, 75 μm, 50 μm, 40 μm, 30 μm, 20 μm, 5 μm, 1 μm, or 0.5 μm. A pre-transformed material layer (or a potion thereof) may have any value in between the afore-mentioned layer thickness values (e.g., from about 1000 μm to about 0.1 μm, 800 μm to about 1 μm, from about 600 μm to about 20 μm, from about 300 μm to about 30 μm, or from about 1000 μm to about 10 μm). The material composition of at least one layer within the material bed may differ from the material composition within at least one other layer in the material bed. The difference (e.g., variation) may comprise difference in crystal or grain structure. The variation may comprise variation in grain orientation, material density, degree of compound segregation to grain boundaries, degree of element segregation to grain boundaries, material phase, metallurgical phase, material porosity, crystal phase, or crystal structure. The microstructure of the printed object may comprise planar structure, cellular structure, columnar dendritic structure, or equiaxed dendritic structure.

The pre-transformed materials of at least one layer in the material bed may differ in the FLS of its particles (e.g., powder particles) from the FLS of the pre-transformed material within at least one other layer in the material bed. A layer may comprise two or more material types at any combination. For example, two or more elemental metals, two or more metal alloys, two or more ceramics, two or more allotropes of elemental carbon. For example, an elemental metal and a metal alloy, an elemental metal and a ceramic, an elemental metal and an allotrope of elemental carbon, a metal alloy and a ceramic, a metal alloy, and an allotrope of elemental carbon, or a ceramic and an allotrope of elemental carbon. All the layers of pre-transformed material deposited during the 3D printing process may be of the same material composition. In some instances, a metal alloy is formed in situ during the process of transforming at least a portion of the material bed. In some instances, a metal alloy is not formed in situ during the process of transforming at least a portion of the material bed. In some instances, a metal alloy is formed prior to the process of transforming at least a portion of the material bed. In a multiplicity (e.g., mixture) of pre-transformed (e.g., powder) materials, one pre-transformed material may be used as support (i.e., supportive powder), as an insulator, as a cooling member (e.g., heat sink), or as any combination thereof.

In some instances, adjacent components in the material bed are separated from one another by one or more intervening layers. In an example, a first layer is adjacent to a second layer when the first layer is in direct contact with the second layer. In another example, a first layer is adjacent to a second layer when the first layer is separated from the second layer by at least one layer (e.g., a third layer). The intervening layer may be of any layer size.

The pre-transformed material (e.g., powder material) can be chosen such that the material is the requested and/or otherwise predetermined material for the 3D object. A layer of the 3D object may comprise (e.g., substantially) a single type of material. For example, a layer of the 3D object may comprise a single elemental metal type, or a single metal alloy type. In some examples, a layer within the 3D object may comprise several types of material (e.g., an elemental metal and an alloy, an alloy and ceramics, or an alloy and an allotrope of elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member (e.g., an allotrope) of elemental carbon (e.g., graphite). In some cases, a layer of the 3D object comprises more than one type of material. In some cases, a layer of the 3D object comprises more than one member of a material type.

The elemental metal can be an alkali metal, an alkaline earth metal, a transition metal, a rare-earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare earth metal can be a lanthanide, or an actinide. The lanthanide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

The metal alloy can be an iron based alloy, nickel based alloy, cobalt based alloy, chrome based alloy, cobalt chrome based alloy, titanium based alloy, magnesium based alloy, copper based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet (e.g., i-pad)), air conditioning, generators, furniture, musical equipment, art, jewelry, cooking equipment, or sport gear. The metal (e.g., alloy or elemental) may comprise an alloy used for products for human and/or veterinary applications comprising implants, or prosthetics. The metal alloy may comprise an alloy used for applications in the fields comprising human and/or veterinary surgery, implants (e.g., dental), or prosthetics.

The alloy may include a superalloy. The alloy may include a high-performance alloy. The alloy may include an alloy exhibiting at least one of: excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy. The alloy may comprise an alloy used for aerospace applications, automotive application, surgical application, or implant applications. The metal may include a metal used for aerospace applications, automotive application, surgical application, or implant applications. The super alloy may comprise IN 738 LC, IN 939, Rene 80, IN 6203 (e.g., IN 6203 DS), PWA 1483 (e.g., PWA 1483 SX), or Alloy 247.

The metal alloys can be Refractory Alloys. The refractory metals and alloys may be used for heat coils, heat exchangers, furnace components, or welding electrodes. The Refractory Alloys may comprise a high melting points, low coefficient of expansion, mechanically strong, low vapor pressure at elevated temperatures, high thermal conductivity, or high electrical conductivity.

In some instances, the iron alloy comprises Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may comprise cast iron, or pig iron. The steel may comprise Bulat steel, Chromoly, Crucible steel, Damascus steel, Hadfield steel, High speed steel, HSLA steel, Maraging steel, Maraging steel (M300), Reynolds 531, Silicon steel, Spring steel, Stainless steel, Tool steel, Weathering steel, or Wootz steel. The high-speed steel may comprise Mushet steel. The stainless steel may comprise AL-6XN, Alloy 20, celestrium, marine grade stainless, Martensitic stainless steel, surgical stainless steel, or Zeron 100. The tool steel may comprise Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade steel such as 440F, 410, 312, 430, 440A, 440B, 440C, 304, 305, 304L, 304L, 301, 304LN, 301LN, 2304, 316, 316L, 316LN, 317L, 2205, 409, 904L, 321, 254SMO, 316Ti, 321H, 304H, 17-4, 15-5, or 420. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may comprise 316L, or 316LVM. The steel may comprise 17-4 Precipitation Hardening steel (e.g., type 630, a chromium-copper precipitation hardening stainless steel, 17-4PH steel).

The titanium-based alloy may comprise alpha alloy, near alpha alloy, alpha and beta alloy, or beta alloy. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy comprises Ti-6Al-4V or Ti-6Al-7Nb.

The Nickel alloy may comprise Alnico, Alumel, Chromel, Cupronickel, Ferronickel, German silver, Hastelloy, Inconel, Monel metal, Nichrome, Nickel-carbon, Nicrosil, Nisil, Nitinol, Hastelloy X, Cobalt-Chromium, or Magnetically “soft” alloys. The magnetically “soft” alloys may comprise Mu-metal, Permalloy, Supermalloy, or Brass. The brass may comprise Nickel hydride, Stainless or Coin silver. The cobalt alloy may comprise Megallium, Stellite (e. g. Talonite), Ultimet, or Vitallium. The chromium alloy may comprise chromium hydroxide, or Nichrome.

The aluminum alloy may comprise AA-8000, Al—Li (aluminum-lithium), Alnico, Duralumin, Hiduminium, Kryron Magnalium, Nambe, Scandium-aluminum, or Y alloy. The magnesium alloy may comprise Elektron, Magnox, or T-Mg—Al—Zn (Bergman phase) alloy.

The copper alloy may comprise Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may comprise Calamine brass, Chinese silver, Dutch metal, Gilding metal, Muntz metal, Pinchbeck, Prince's metal, or Tombac. The Bronze may comprise Aluminum bronze, Arsenical bronze, Bell metal, Florentine bronze, Guanin, Gunmetal, Glucydur, Phosphor bronze, Ormolu, or Speculum metal. The copper alloy may be a high-temperature copper alloy (e.g., GRCop-84).

In some examples, the material (e.g., powder material) comprises a material wherein its constituents (e.g., atoms or molecules) readily lose their outer shell electrons, resulting in a free-flowing cloud of electrons within their otherwise solid arrangement. In some examples the material is characterized in having high electrical conductivity, low electrical resistivity, high thermal conductivity, or high density (e.g., as measured at ambient temperature (e.g., R.T., or 20° C.)). The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the afore-mentioned electrical conductivity values (e.g., from about 1*10⁵ S/m to about 1*10⁸ S/m). The thermal conductivity, electrical resistivity, electrical conductivity, electrical resistivity, and/or density can be measured at ambient temperature (e.g., at R.T., or 20° C.). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the afore-mentioned electrical resistivity values (e.g., from about 1×10⁻⁵ Ω*m to about 1×10⁻⁸ Ω*m). The high thermal conductivity may be at least about 20 Watts per meters times degrees Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the afore-mentioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore-mentioned density values (e.g., from about 1 g/cm³ to about 25 g/cm³).

A metallic material (e.g., elemental metal or metal alloy) can comprise small amounts of non-metallic materials, such as, for example, oxygen, sulfur, or nitrogen. In some cases, the metallic material can comprise the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (based on weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (based on weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

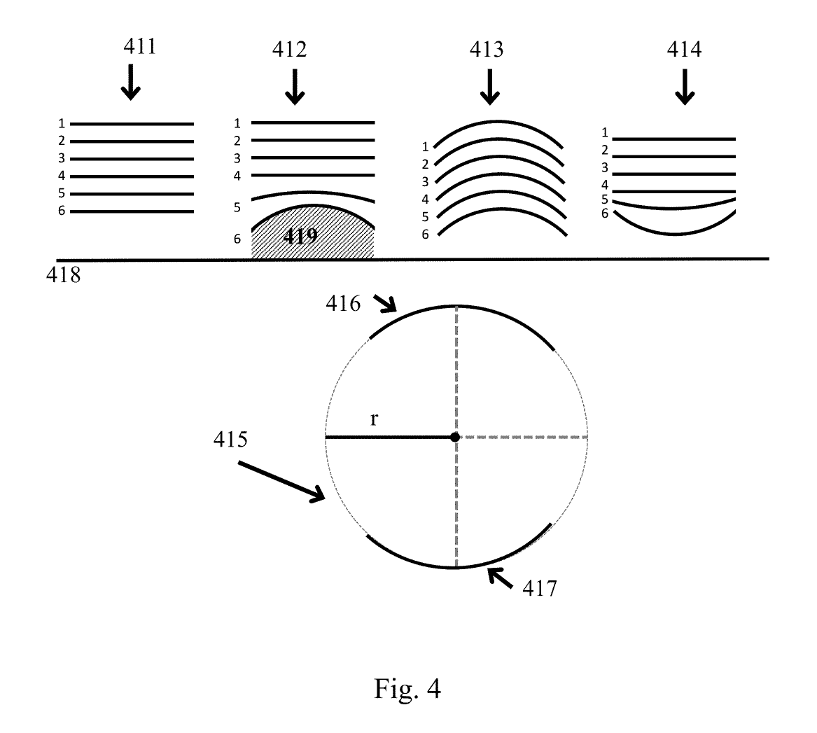

The one or more layers within the 3D object may be (e.g., substantially) planar (e.g., flat). The planarity of the layer may be (e.g., substantially) uniform. The height of the layer at a particular position may be compared to an average plane. The average plane may be defined by a least squares planar fit of the top-most part of the surface of the layer of hardened material. The average plane may be a plane calculated by averaging the material height at each point on the top surface of the layer of hardened material. The deviation from any point at the surface of the planar layer of hardened material may be at most 20% 15%, 10%, 5%, 3%, 1%, or 0.5% of the height (e.g., thickness) of the layer of hardened material. The (e.g., substantially) planar one or more layers may have a large radius of curvature. FIG. 4 shows an example of a vertical cross section of a 3D object 412 comprising planar layers (layers numbers 1-4) and non-planar layers (e.g., layers numbers 5-6) that have a radius of curvature. FIGS. 4, 416 and 417 are super-positions of curved layer on a circle 415 having a radius of curvature “r.” The one or more layers may have a radius of curvature equal to the radius of curvature of the layer surface. The radius of curvature may equal infinity (e.g., when the layer is flat). The radius of curvature of the layer surface (e.g., all the layers of the 3D object) may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 3 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the layer surface (e.g., all the layers of the 3D object) may have a value of at most about 0.1 centimeter (cm), 0.2 cm, 0.3 cm, 0.4 cm, 0.5 cm, 0.6 cm, 0.7 cm, 0.8 cm, 0.9 cm, 1 cm, 3 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, 100 m, or infinity (i.e., flat layer). The radius of curvature of the layer surface (e.g., all the layers of the 3D object) may have any value between any of the afore-mentioned values of the radius of curvature (e.g., from about 10 cm to about 90 m, from about 50 cm to about 10 m, from about 5 cm to about 1 m, from about 50 cm to about 5 m, from about 5 cm to infinity, or from about 40 cm to about 50 m). In some embodiments, a layer with an infinite radius of curvature is a layer that is planar. In some examples, the one or more layers may be included in a planar section of the 3D object, or may be a planar 3D object (e.g., a flat plane). In some instances, part of at least one layer within the 3D object may have any of the radii of curvature mentioned herein, which will designate the radius of curvature of that layer portion.

The 3D object may comprise a layering plane N of the layered structure. FIG. 7C shows an example of a 3D object having a layered structure, wherein 705 shows an example of a side view of a plane, wherein 701 shows an example of a layering plane. The layering plane may be the average or mean plane of a layer of hardened material (as part of the 3D object). The 3D object may comprise points X and Y, which reside on the surface of the 3D object, wherein X is spaced apart from Y by at least about 10.5 millimeters or more. FIG. 5 shows an example of points X and Y on the surface of a 3D object. In some embodiments, X is spaced apart from Y by the auxiliary feature spacing distance. A sphere of radius XY that is centered at X lacks one or more auxiliary supports or one or more auxiliary support marks that are indicative of a presence or removal of the one or more auxiliary support features. In some embodiments, Y is spaced apart from X by at least about 10.5 millimeters or more. An acute angle between the straight line XY and the direction normal to N may be from about 45 degrees to about 90 degrees. The acute angle between the straight line XY and the direction normal to the layering plane may be of the value of the acute angle alpha. When the angle between the straight line XY and the direction of normal to N is greater than 90 degrees, one can consider the complementary acute angle. The layer structure may comprise any material(s) used for 3D printing. Each layer of the 3D structure (e.g., 3D object) can be made of a single material or of multiple materials. Sometimes one part of the layer may comprise one material, and another part may comprise a second material different than the first material. A layer of the 3D object may be composed of a composite material. The 3D object may be composed of a composite material. The 3D object may comprise a functionally graded material.

In some embodiments, the generated 3D object may be generated with the accuracy of at least about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm with respect to a model of the 3D object (e.g., the desired 3D object). The generated 3D object may be generated with the accuracy of at most about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm with respect to (e.g., deviated from) a model of the 3D object. With respect to a model of the 3D object, the generated 3D object may be generated with the accuracy of any accuracy value between the afore-mentioned values (e.g., from about 5 μm to about 100 μm, from about 15 μm to about 35 μm, from about 100 μm to about 1500 μm, from about 5 μm to about 1500 μm, or from about 400 μm to about 600 μm).

The hardened layer of transformed material may deform. The deformation may cause a vertical (e.g., height) and/or lateral (e.g., width and/or length) deviation from a desired uniformly planar layer of hardened material. The vertical and/or lateral deviation of the planar surface of the layer of hardened material may be at least about 100 μm, 90 μm, 80 μm, 70 μm, 60 μm, 50 μm, 40 μm, 30 μm, 20 μm, 10 μm, or 5 μm. The vertical and/or lateral deviation of the planar surface of the layer of hardened material may be at most about 100 μm, 90 μm, 80, 70 μm, 60 μm, 50 μm, 40 μm, 30 μm, 20 μm, 10 μm, or 5 μm. The vertical and/or lateral deviation of the planar surface of the layer of hardened material may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dip. The resolution of the 3D object may be any value between the afore-mentioned values (e.g., from 100 dpi to 4800 dpi, from 300 dpi to 2400 dpi, or from 600 dpi to 4800 dpi). A dot may be a melt pool. A dot may be a step. A dot may be a height of the layer of hardened material. A step may have a value of at most the height of the layer of hardened material.

The vertical (e.g., height) uniformity of a layer of hardened material may persist across a portion of the layer surface that has a FLS (e.g., a width and/or a length) of at least about 1 mm, 2 mm, 3 mm, 4 mm, 5 mm, or 10 mm, have a height deviation of at least about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm. The height uniformity of a layer of hardened material may persist across a portion of the target surface that has a FLS (e.g., a width and/or a length) of most about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80, 70 μm, 60 μm, 50 μm, 40 μm, 30 μm, 20 μm, or 10 μm. The height uniformity of a layer of hardened material may persist across a portion of the target surface that has a FLS (e.g., a width and/or a length) of any value between the afore-mentioned width or length values (e.g., from about 10 mm to about 10 μm, from about 10 mm to about 100 μm, or from about 5 mm to about 500 μm). The target surface may be a layer of hardened material (e.g., as part of the 3D object).

Characteristics of the 3D object (e.g., hardened material) and/or any of its parts (e.g., layer of hardened material) can be measured by any of the following measurement methodologies. For example, the FLS values (e.g., width, height uniformity, auxiliary support space, and or radius of curvature) of the layer of the 3D object and any of its components (e.g., layer of hardened material) may be measured by any of the following measuring methodologies. The measurement methodologies may comprise a microscopy method (e.g., any microscopy method described herein). The measurement methodologies may comprise a coordinate measuring machine (CMM), measuring projector, vision measuring system, and/or a gauge. The gauge can be a gauge distometer (e.g., caliber). The gauge can be a go-no-go gauge. The measurement methodologies may comprise a caliber (e.g., vernier caliber), positive lens, interferometer, or laser (e.g., tracker). The measurement methodologies may comprise a contact or by a non-contact method. The measurement methodologies may comprise one or more sensors (e.g., optical sensors and/or metrological sensors). The measurement methodologies may comprise a metrological measurement device (e.g., using metrological sensor(s)). The measurements may comprise a motor encoder (e.g., rotary, and/or linear). The measurement methodologies may comprise using an electromagnetic beam (e.g., visible or IR). The microscopy method may comprise ultrasound or nuclear magnetic resonance. The microscopy method may comprise optical microscopy. The microscopy method may comprise electromagnetic, electron, or proximal probe microscopy. The electron microscopy may comprise scanning, tunneling, X-ray photo-, or Auger electron microscopy. The electromagnetic microscopy may comprise confocal, stereoscope, or compound microscopy. The microscopy method may comprise an inverted or non-inverted microscope. The proximal probe microscopy may comprise atomic force, scanning tunneling microscopy, or any other microscopy method. The microscopy measurements may comprise using an image analysis system. The measurements may be conducted at ambient temperatures (e.g., R.T.), melting point temperature (e.g., of the pre-transformed material) or cryogenic temperatures.

The microstructures (e.g., of melt pools) of the 3D object may be measured by a microscopy method (e.g., any microscopy method described herein). The microstructures may be measured by a contact or by a non-contact method. The microstructures may be measured by using an electromagnetic beam (e.g., visible or IR). The microstructure measurements may comprise evaluating the dendritic arm spacing and/or the secondary dendritic arm spacing (e.g., using microscopy). The microscopy measurements may comprise an image analysis system. The measurements may be conducted at ambient temperatures (e.g., R.T.), melting point temperature (e.g., of the pre-transformed material) or cryogenic temperatures.

Various distances relating to the chamber can be measured using any of the following measurement techniques. Various distances within the chamber can be measured using any of the measurement techniques. For example, the gap distance (e.g., from the cooling member to the exposed surface of the material bed) may be measured using any of the measurement techniques. The measurements techniques may comprise interferometry and/or confocal chromatic measurements. The measurements techniques may comprise at least one motor encoder (rotary, linear). The measurement techniques may comprise one or more sensors (e.g., optical sensors and/or metrological sensors). The measurement techniques may comprise at least one inductive sensor. The measurement techniques may include an electromagnetic beam (e.g., visible or IR). The measurements may be conducted at ambient temperatures (e.g., R.T.), melting point temperature (e.g., of the pre-transformed material) or cryogenic temperatures.

The methods described herein can provide surface uniformity across the exposed surface of the material bed (e.g., top of a powder bed) such that portions of the exposed surface that comprises the dispensed material, which are separated from one another by a distance of from about 1 mm to about 10 mm, have a vertical (e.g., height) deviation from about 100 μm to about 5 μm. The methods described herein may achieve a deviation from a planar uniformity of the layer of pre-transformed material (e.g., powder) in at least one plane (e.g., horizontal plane) of at most about 20%, 10%, 5%, 2%, 1% or 0.5%, as compared to the average or mean plane (e.g., horizontal plane) created at the exposed surface of the material bed (e.g., top of a powder bed) and/or as compared to the platform (e.g., building platform). The vertical deviation can be measured by using one or more sensors (e.g., optical sensors).

The 3D object can have various surface roughness profiles, which may be suitable for various applications. The surface roughness may be the deviations in the direction of the normal vector of a real surface, from its ideal form. The surface roughness may be measured as the arithmetic average of the roughness profile (hereinafter “Ra”). The 3D object can have a Ra value of at least about 300 μm, 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The formed object can have a Ra value of at most about 300 μm, 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The 3D object can have a Ra value between any of the afore-mentioned Ra values (e.g., from about 300 μm to about 50 μm, from about 50 μm to about 5 μm, from about 5 μm to about 300 nm, from about 300 nm to about 30 nm, or from about 300 μm to about 30 nm). The Ra values may be measured by a contact or by a non-contact method. The Ra values may be measured by a roughness tester and/or by a microscopy method (e.g., any microscopy method described herein). The measurements may be conducted at ambient temperatures (e.g., R.T.), melting point temperature (e.g., of the pre-transformed material) or cryogenic temperatures. The roughness may be measured by a contact or by a non-contact method. The roughness measurement may comprise one or more sensors (e.g., optical sensors). The roughness measurement may comprise using a metrological measurement device (e.g., using metrological sensor(s)). The roughness may be measured using an electromagnetic beam (e.g., visible or IR).

The 3D object may be composed of successive layers of solid material that originated from a transformed material (e.g., and subsequently hardened). The successive layers of solid material may correspond to successive cross sections of a desired (e.g., requested) 3D object. For example, the transformed (e.g., powder) material may connect (e.g., weld) to a hardened (e.g., solidified) material. The hardened material may reside within the same layer as the transformed material, or in another layer (e.g., a previous layer). In some examples, the hardened material comprises disconnected parts of 3D object, that are subsequently connected by newly transformed material. Transforming may comprise fusing, binding or otherwise connecting the pre-transformed material (e.g., connecting the particulate material). Fusing may comprise sintering or melting.

A cross section (e.g., vertical cross section) of the generated (i.e., formed) 3D object may reveal a microstructure or a grain structure indicative of a layered deposition. Without wishing to be bound to theory, the microstructure or grain structure may arise due to the solidification of transformed material that is typical to and/or indicative of the 3D printing method. For example, a cross section may reveal a microstructure resembling ripples or waves that are indicative of solidified melt pools that may be formed during the 3D printing process. FIGS. 7A and 7B show examples of successive melt pool in a 3D object that are arranged in layers.

The repetitive layered structure of the solidified melt pools relative to an external plane of the 3D object may reveal the orientation at which the part was printed, since the deposition of the melt pools is in a substantially horizontal plane. FIG. 7C shows examples of 3D objects that are formed by layer wise deposition, which layer orientation with respect to an external plane of the 3D object reveals the orientation of the object during its 3D printing. For example, a 3D object having an external plane 701 was formed in a manner that both the external plane 701 and the layers of hardened material (e.g., 705) were formed substantially parallel to the platform 703. For example, a 3D object having an external plane 702 was formed in a way that the external plane 702 formed an angle with the platform 703, whereas the layers of hardened material (e.g., 706) were formed substantially parallel to the platform 703. The 3D object having an external plane 704 shows an example of a 3D object that was generated such that its external plane 704 formed an angle (e.g., alpha) with the platform 703; which printed 3D object was placed on the platform 703 after its generation was complete; whereas during its generation (e.g., build), the layers of hardened material (e.g., 707) were oriented substantially parallel to the platform 703.

The cross section of the 3D object may reveal a substantially repetitive microstructure or grain structure. The microstructure or grain structure may comprise substantially repetitive variations in material composition, grain orientation, material density, degree of compound segregation or of element segregation to grain boundaries, material phase, metallurgical phase, crystal phase, crystal structure, material porosity, or any combination thereof. The microstructure or grain structure may comprise substantially repetitive solidification of layered melt pools. (e.g., FIGS. 7A-7B). The substantially repetitive microstructure may have an average height of at least about 0.5 μm, 1 μm, 5 μm, 7 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, 500 μm, or 1000 μm. The substantially repetitive microstructure may have an average height of at most about 1000 μm, 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, or 10 μm. The substantially repetitive microstructure may have an average height of any value between the afore-mentioned values (e.g., from about 0.5 μm to about 1000 μm, from about 15 μm to about 50 μm, from about 5 μm to about 150 μm, from about 20 μm to about 100 μm, or from about 10 μm to about 80 μm). The microstructure (e.g., melt pool) height may correspond to the height of a layer of hardened material. The layer height is can be seen in the example in FIG. 7C showing a layer of hardened material with a height that is pointed to by arrow 705.

The 3D object may comprise a reduced amount of constraints (e.g., supports). The reduced amount may be relative to prevailing 3D printing methodologies in the art (e.g., respective methodologies). The 3D object may be less constraint (e.g., relative to prevailing 3D printing methodologies in the art). The 3D object may be constraint-less (e.g., support-less).

The pre-transformed material within the material bed (e.g., powder) can be configured to provide support to the 3D object. For example, the supportive powder may be of the same type of powder from which the 3D object is generated, of a different type, or any combination thereof. The pre-transformed material may be a powder. The powder may be flowable (e.g., during the 3D printing). The powder in any of the disposed layers in the material bed may be flowable (e.g., during the 3D printing). Before, during and/or at the end of the 3D printing process, the pre-transformed material (e.g., powder) that did not transform may be flowable. The powder that did not transform to form the 3D object (or a portion thereof) may be referred to as a “remainder.” In some instances, a low flowability powder can be capable of supporting a 3D object better than a high flowability powder. A low flowability powder can be achieved inter alia with a powder composed of relatively small particles, with particles of non-uniform size or with particles that attract each other. The powder may be of low, medium, or high flowability. The powder material may have compressibility of at least about 1%, 2%, 3%, 4%, 5%, 6%, 7%, 8%, 9%, or 10% in response to an applied force of 15 kilo Pascals (kPa). The powder may have a compressibility of at most about 9%, 8%, 7%, 6%, 5%, 4.5%, 4.0%, 3.5%, 3.0%, 2.5%, 2.0%, 1.5%, 1.0%, or 0.5% in response to an applied force of 15 kilo Pascals (kPa). The powder may have basic flow energy of at least about 100 milli-Joule (mJ), 200 mJ, 300 mJ, 400 mJ, 450 mJ, 500 mJ, 550 mJ, 600 mJ, 650 mJ, 700 mJ, 750 mJ, 800 mJ, or 900 mJ. The powder may have basic flow energy of at most about 200 mJ, 300 mJ, 400 mJ, 450 mJ, 500 mJ, 550 mJ, 600 mJ, 650 mJ, 700 mJ, 750 mJ, 800 mJ, 900 mJ, or 1000 mJ. The powder may have basic flow energy in between the above listed values of basic flow energy values (e.g., from about 100 mj to about 1000 mJ, from about 100 mj to about 600 mJ, or from about 500 mj to about 1000 mJ). The powder may have a specific energy of at least about 1.0 milli-Joule per gram (mJ/g), 1.5 mJ/g, 2.0 mJ/g, 2.5 mJ/g, 3.0 mJ/g, 3.5 mJ/g, 4.0 mJ/g, 4.5 mJ/g, or 5.0 mJ/g. The powder may have a specific energy of at most 5.0 mJ/g, 4.5 mJ/g, 4.0 mJ/g, 3.5 mJ/g, 3.0 mJ/g, 2.5 mJ/g, 2.0 mJ/g, 1.5 mJ/g, or 1.0 mJ/g. The powder may have a specific energy in between any of the above values of specific energy (e.g., from about 1.0 mJ/g to about 5.0 mJ/g, from about 3.0 mJ/g to about 5 mJ/g, or from about 1.0 mJ/g to about 3.5 mJ/g).

During its formation (e.g., layer wise generation), the 3D object can have one or more auxiliary features. During its formation (e.g., layer wise generation), the 3D object can be devoid of any auxiliary features. The auxiliary feature(s) can be supported by the material (e.g., powder) bed and/or by the enclosure. In some instances, the auxiliary supports may connect to the enclosure (e.g., the platform). In some instances, the auxiliary supports may not connect (e.g., be anchored) to the enclosure (e.g., the platform). In some instances, the auxiliary supports may not connect to the enclosure, but contact the enclosure. The 3D object comprising one or more auxiliary supports, or devoid of auxiliary supports may be suspended (e.g., float) in the material bed. The floating 3D object (with or without the one or more auxiliary supports) may contact the enclosure.

The term “auxiliary features,” as used herein, generally refers to features that are part of a printed 3D object, but are not part of the desired, intended, designed, ordered, modeled, or final 3D object. Auxiliary feature(s) (e.g., auxiliary supports) may provide structural support during and/or after the formation of the 3D object. Auxiliary features may enable the removal of energy from the 3D object while it is being formed. Examples of auxiliary features comprise heat fins, wires, anchors, handles, supports, pillars, columns, frame, footing, scaffold, flange, projection, protrusion, mold (a.k.a. mould), platform (e.g., base), or other stabilization features. In some instances, the auxiliary support is a scaffold that encloses the 3D object or part thereof. The scaffold may comprise lightly sintered or lightly fused powder material. The 3D object can have auxiliary features that can be supported by the material bed (e.g., powder bed) and not touch the base, substrate, container accommodating the material bed, and/or the bottom of the enclosure. During its 3D printing, the 3D part (3D object) in a complete or partially formed state can be completely supported by the material bed (e.g., without being anchored to the substrate, base, container accommodating the powder bed, or enclosure). During its 3D printing, the 3D object in a complete or partially formed state can be (completely) supported by the material bed (e.g., without touching anything except the material bed). During its 3D printing, the 3D object in a complete or partially formed state can be suspended in the powder bed without resting on any additional support structures. In some cases, the 3D object in a complete or partially formed (i.e., nascent) state can freely float (e.g., anchorless) in the material bed (e.g., during its 3D printing). Suspended may be floating, disconnected, anchorless, detached, non-adhered, or free. In some examples, the 3D object may not be anchored (e.g., connected) to at least a part of the enclosure (e.g., during formation of the 3D object, and/or during formation of at least one layer of the 3D object). The enclosure may comprise a platform or wall that define the material bed. The 3D object may not touch and/or not contact enclosure (e.g., during formation of at least one layer of the 3D object). The 3D object be suspended (e.g., float) in the material bed (e.g., during the 3D printing). The scaffold may comprise a continuously sintered (e.g., lightly sintered) structure that is at most 1 millimeter (mm), 2 mm, 5 mm or 10 mm. The scaffold may comprise a continuously sintered structure that is at least 1 millimeter (mm), 2 mm, 5 mm or 10 mm. The scaffold may comprise a continuously sintered structure having dimensions between any of the afore-mentioned dimensions (e.g., from about 1 mm to about 10 mm, or from about 1 mm to about 5 mm). In some examples, the 3D object may be printed without a supporting scaffold. The supporting scaffold may engulf at least a portion of the 3D object (e.g., the entire 3D object). For example, a supporting scaffold that floats in the material bed, or that is connected to at least a portion of the enclosure.

The printed 3D object (or at least one portion thereof) may be printed without the use of auxiliary features, may be printed using a reduced number of auxiliary features, or printed using spaced apart auxiliary features. In some embodiments, the printed 3D object may be devoid of (one or more) auxiliary support features or auxiliary support feature marks that are indicative of a presence or removal of the auxiliary support feature(s) (e.g., during the 3D printing). The 3D object may be devoid of one or more auxiliary support features and of one or more marks of an auxiliary feature (including a base structure) that was removed (e.g., subsequent to, or contemporaneous with, the generation of the 3D object). The printed 3D object may comprise a single auxiliary support mark. The single auxiliary feature (e.g., auxiliary support or auxiliary structure) may be a platform (e.g., a building platform such as a base or substrate), or a mold. The auxiliary support may be adhered to the platform or mold. The 3D object may comprise marks belonging to one or more auxiliary structures. The 3D object may comprise two or more marks belonging to auxiliary feature(s). The 3D object may be devoid of marks pertaining to at least one auxiliary support. The 3D object may be devoid of one or more auxiliary support. The mark may comprise variation in grain orientation, variation in layering orientation, layering thickness, material density, the degree of compound segregation to grain boundaries, material porosity, the degree of element segregation to grain boundaries, material phase, metallurgical phase, crystal phase, or crystal structure; wherein the variation may not have been created by the geometry of the 3D object alone, and may thus be indicative of a prior existing auxiliary support that was removed. The variation may be forced upon the generated 3D object by the geometry of the support. In some instances, the 3D structure of the printed object may be forced by the auxiliary support(s) (e.g., by a mold). For example, a mark may be a point of discontinuity that is not explained by the geometry of the 3D object, which does not include any auxiliary support(s). A mark may be a surface feature that cannot be explained by the geometry of a 3D object, which does not include any auxiliary support(s) (e.g., a mold). The two or more auxiliary features or auxiliary support feature marks may be spaced apart by a spacing distance of at least 1.5 millimeters (mm), 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The two or more auxiliary support features or auxiliary support feature marks may be spaced apart by a spacing distance of at most 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The two or more auxiliary support features or auxiliary support feature marks may be spaced apart by a spacing distance of any value between the afore-mentioned auxiliary support space values (e.g., from 1.5 mm to 500 mm, from 2 mm to 100 mm, from 15 mm to 50 mm, or from 45 mm to 200 mm). Collectively referred to herein as the “auxiliary feature spacing distance.”

The 3D object (or at least one portion thereof) may comprise a layered structure indicative of 3D printing process that is devoid of one or more auxiliary support features or one or more auxiliary support feature marks that are indicative of a presence or removal of the one or more auxiliary support features. The 3D object may comprise a layered structure indicative of 3D printing process, which includes one, two, or more auxiliary support marks. The auxiliary support structure may comprise a supporting scaffold. The supporting scaffold may comprise a dense arrangement (e.g., array) of support structures. The support(s) or support mark(s) can stem from or appear on the surface of the 3D object. The auxiliary supports or support marks can stem from or appear on an external surface and/or on an internal surface (e.g., a cavity within the 3D object). The layered 3D structure can have a layering plane. In one example, two auxiliary support features or auxiliary support feature marks present in the 3D object may be spaced apart by the auxiliary feature spacing distance. FIG. 6 shows an example of a coordinate system that can be used to represent various examples. In an example: line 604 represents a vertical cross section of a layering plane; line 603 represents the straight line connecting the two auxiliary supports or auxiliary support marks; line 602 represent the normal to the layering plane and to the gravitational field; and line 601 represents the direction of the gravitational field. The acute (i.e., sharp) angle alpha between the straight line connecting the two auxiliary supports or auxiliary support marks and the direction of normal to the layering plane may be at least about 45) degrees (°), 50°, 55°, 60°, 65°, 70°, 75°, 80°, or 85°. The acute angle alpha between the straight line connecting the two auxiliary supports or auxiliary support marks and the direction of normal to the layering plane may be at most about 90°, 85°, 80°, 75°, 70°, 65°, 60°, 55°, 50°, or 45°. The acute angle alpha between the straight line connecting the two auxiliary supports or auxiliary support marks and the direction of normal to the layering plane may be any angle range between the afore-mentioned angles (e.g., from about 45 degrees (°), to about 90°, from about 60° to about 90°, from about 75° to about 90°, from about 80° to about 90°, or from about 85° to about 90°). The acute angle alpha between the straight line connecting the two auxiliary supports or auxiliary support marks and the direction normal to the layering plane may from about 87° to about 90°. An example of a layering plane can be seen in FIG. 4, showing a vertical cross section of a 3D object 411 that comprises layers 1 to 6, each of which are substantially planar. In the schematic example shown in FIG. 4, the layering plane of the layers can be the depicted line (e.g., 411, #1). For example, layer 1 could correspond to both the layer and the layering plane of layer 1. When the layer is not planar (e.g., FIG. 4, layer 5 of 3D object 412), the layering plane would be the average plane of the layer. The two auxiliary supports or auxiliary support feature marks can be on the same surface (e.g., external surface of the 3D object). The same surface can be an external surface or an internal surface (e.g., a surface of a cavity within the 3D object). When the angle between the shortest straight line connecting the two auxiliary supports or auxiliary support marks and the direction of normal to the layering plane is greater than 90 degrees, one can consider the complementary acute angle. In some embodiments, any two auxiliary supports or auxiliary support marks are spaced apart by at least about 10.5 millimeters or more. In some embodiments, any two auxiliary supports or auxiliary support marks are spaced apart by at least about 40.5 millimeters or more. In some embodiments, any two auxiliary supports or auxiliary support marks are spaced apart by the auxiliary feature spacing distance. FIG. 7C shows an example of a 3D object comprising an exposed surface 701 that was formed with layers of hardened material (e.g., having layering plane 705) that are substantially parallel to the platform 703. FIG. 7C shows an example of a 3D object comprising an exposed surface 702 that was formed with layers of hardened material (e.g., having layering plane 706) that are substantially parallel to the platform 703 resulting in a tilted 3D object (e.g., box). The 3D object that was formed as a tiled object, is shown subsequent to its generation, lying on a surface 709 as a 3D object having an exposed surface 704 and layers of hardened material (e.g., having layering plane 707) having a normal 708 to the layering plane that forms acute angle alpha with the exposed surface 704 of the 3D object. FIGS. 7A and 7B show 3D objects comprising layers of solidified melt pools that are arranged in layers having layering planes (e.g., 720).

During its 3D printing, the 3D object can be formed without one or more auxiliary features and/or without contacting a platform (e.g., a base, a substrate, or a bottom of an enclosure). The one or more auxiliary features (which may include a base support) can be used to hold or restrain the 3D object during formation. In some cases, auxiliary features can be used to anchor and/or hold a 3D object or a portion of a 3D object in a material bed (e.g., with or without contacting the enclosure, or with or without connecting to the enclosure). The one or more auxiliary features can be specific to a 3D object and can increase the time, energy, material and/or cost required to form the 3D object. The one or more auxiliary features can be removed prior to use or distribution of the 3D object. The longest dimension of a cross-section of an auxiliary feature can be at most about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension (e.g., FLS) of a cross-section of an auxiliary feature can be at least about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension of a cross-section of an auxiliary feature can be any value between the above-mentioned values (e.g., from about 50 nm to about 300 mm, from about 5 μm to about 10 mm, from about 50 nm to about 10 mm, or from about 5 mm to about 300 mm). Eliminating the need for auxiliary features can decrease the time, energy, material, and/or cost associated with generating the 3D object (e.g., 3D part). In some examples, the 3D object may be formed with auxiliary features. In some examples, the 3D object may be formed while connecting to the container accommodating the material bed (e.g., side(s) and/or bottom of the container).

In some examples, the diminished number of auxiliary supports or lack of one or more auxiliary supports, will provide a 3D printing process that requires a smaller amount of material, energy, material, and/or cost as compared to commercially available 3D printing processes. In some examples, the diminished number of auxiliary supports or lack of one or more auxiliary supports, will provide a 3D printing process that produces a smaller amount of material waste as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforesaid values (e.g., from about 1.1 to about 10, or from about 1.5 to about 5).

At least a portion of the 3D object can be vertically displaced (e.g., sink) in the material bed. At least a portion of the 3D object can be surrounded by pre-transformed material within the material bed (e.g., submerged). At least a portion of the 3D object can rest in the pre-transformed material without substantial vertical movement (e.g., displacement). Lack of substantial vertical displacement can amount to a vertical movement (e.g., sinking) of at most about 40%, 20%, 10%, 5%, or 1% of the layer thickness. Lack of substantial sinking can amount to at most about 100 μm, 30 μm, 10 μm, 3 μm, or 1 μm. At least a portion of the 3D object can rest in the pre-transformed material without substantial movement (e.g., horizontal, vertical, and/or angular). Lack of substantial movement can amount to a movement of at most 100 μm, 30 μm, 10 μm, 3 μm, or 1 μm. The 3D object can rest on the substrate when the 3D object is vertically displaced (e.g., sunk) or submerged in the material bed.

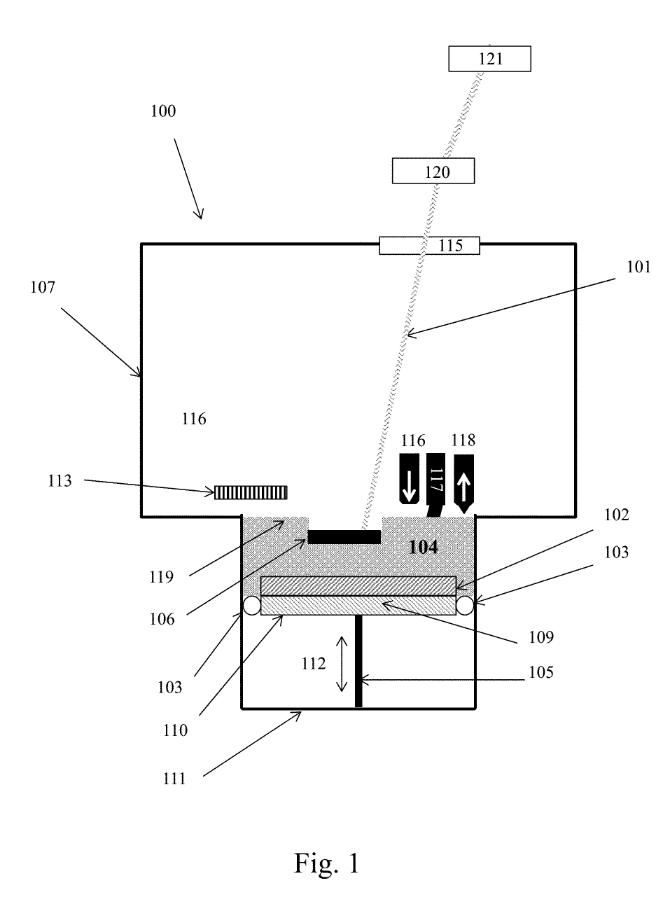

FIG. 1 depicts an example of a system that can be used to generate a 3D object using a 3D printing process disclosed herein. The system can include an enclosure (e.g., a chamber 107). At least a fraction of the components in the system can be enclosed in the chamber. At least a fraction of the chamber can be filled with a gas to create a gaseous environment (i.e., an atmosphere). The gas can be an inert gas (e.g., Argon, Neon, Helium, Nitrogen). The chamber can be filled with another gas or mixture of gases. The gas can be a non-reactive gas (e.g., an inert gas). The gaseous environment can comprise argon, nitrogen, helium, neon, krypton, xenon, hydrogen, carbon monoxide, or carbon dioxide. The pressure in the chamber can be at least 10⁻⁷ Torr, 10⁻⁶ Torr, 10⁻⁵ Torr, 10⁻⁴ Torr, 10⁻³ Torr, 10⁻¹ Torr, 10¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, or 1000 bar. The pressure in the chamber can be at least about 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at most about 10⁻⁷ Torr, 10⁻⁶ Torr, 10⁻⁵ Torr, or 10⁻⁴ Torr, 10⁻³ Torr, 10⁻² Torr, 10⁻¹ Torr, 1 Torr, 10 Torr, 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at a range between any of the afore-mentioned pressure values (e.g., from about 10⁻⁷ Torr to about 1200 Torr, from about 10⁻⁷ Torr to about 1 Torr, from about 1 Torr to about 1200 Torr, or from about 10⁻² Torr to about 10 Torr). The pressure can be measured by a pressure gauge. The pressure can be measured at ambient temperature (e.g., R.T.), cryogenic temperature, or at the temperature of the melting point of the pre-transformed material. In some cases, the pressure in the chamber can be standard atmospheric pressure. In some cases, the pressure in the chamber can be ambient pressure (i.e., neutral pressure). In some examples, the chamber can be under vacuum pressure. In some examples, the chamber can be under a positive pressure (i.e., above ambient pressure).

The chamber can comprise two or more gaseous layers. The gaseous layers can be separated by molecular weight or density such that a first gas with a first molecular weight or density is located in a first region, and a second gas with a second molecular weight or density is located in a second region of the chamber above or below the first region. The first molecular weight or density may be smaller than the second molecular weight or density. The first molecular weight or density may be larger than the second molecular weight or density. The gaseous layers can be separated by a temperature difference. The first gas can be in a lower region of the chamber relative to the second gas. The second gas and the first gas can be in adjacent locations. The second gas can be on top of, over, and/or above the first gas. In some cases, the first gas can be argon and the second gas can be helium. The molecular weight or density of the first gas can be at least about 1.5*, 2*, 3*, 4*, 5*, 10*, 15*, 20*, 25*, 30*, 35*, 40*, 50*, 55*, 60*, 70*, 75*, 80*, 90*, 100*, 200*, 300*, 400*, or 500* larger or greater than the molecular weight or density of the second gas (e.g., measured at ambient temperature). The molecular weight of the first gas can be higher than the molecular weight of air. The molecular weight or density of the first gas can be higher than the molecular weight or density of oxygen gas (e.g., O₂). The molecular weight or density of the first gas can be higher than the molecular weight or density of nitrogen gas (e.g., N₂). The molecular weight or density of the first gas may be lower than that of oxygen gas and/or nitrogen gas.

The first gas with the relatively higher molecular weight or density can fill a region of the system where at least a fraction of the pre-transformed material (e.g., powder) is stored. The first gas with the relatively higher molecular weight or density can fill a region of the system and/or apparatus where the 3D object is formed. Alternatively, the second gas with the relatively lower molecular weight or density can fill a region of the system and/or apparatus where the 3D object is formed. The material layer can be supported on a platform. The platform may comprise a substrate (e.g., 109). The substrate can have a circular, rectangular, square, or irregularly shaped cross-section. The platform may comprise a base disposed above the substrate. The platform may comprise a base (e.g., 102) disposed between the substrate and a material layer (or a space to be occupied by a material layer). A thermal control unit (e.g., a cooling member such as a heat sink or a cooling plate, or a heating plate 113) can be provided inside of the region where the 3D object is formed or adjacent to (e.g., above) the region where the 3D object is formed. The thermal control unit may comprise a thermostat. Additionally, or alternatively, the thermal control unit can be provided outside of the region where the 3D object is formed (e.g., at a predetermined distance). In some cases, the thermal control unit can form at least one section of a boundary region where the 3D object is formed (e.g., the container accommodating the material bed).

The concentration of oxygen and/or humidity in the enclosure (e.g., chamber) can be minimized (e.g., below a predetermined threshold value). The gas composition of the chamber may contain a level of oxygen and/or humidity that is at most about 100 parts per billion (ppb), 10 ppb, 1 ppb, 0.1 ppb, 0.01 ppb, 0.001 ppb, 100 parts per million (ppm), 10 ppm, 1 ppm, 0.1 ppm, 0.01 ppm, or 0.001 ppm. The gas composition of the chamber can contain an oxygen and/or humidity level between any of the afore-mentioned values (e.g., from about 100 ppb to about 0.001 ppm, from about 1 ppb to about 0.01 ppm, or from about 1 ppm to about 0.1 ppm). The gas composition may be measures by one or more sensors (e.g., an oxygen and/or humidity sensor). The chamber can be opened at the completion of a formation of a 3D object. When the chamber is opened, ambient air containing oxygen and/or humidity can enter the chamber. Exposure of one or more components inside the chamber to air can be reduced by, for example, flowing an inert gas while the chamber is open (e.g., to prevent entry of ambient air), or by flowing a heavy gas (e.g., argon) that rests on the surface of the material bed. In some cases, components that absorb oxygen and/or humidity on to their surface(s) can be sealed while the enclosure (e.g., chamber) is open (e.g., to the ambient environment).

The chamber can be configured such that gas inside of the chamber has a relatively low leak rate from the chamber to an environment outside of the chamber. In some cases, the leak rate can be at most about 100 milliTorr/minute (mTorr/min), 50 mTorr/min, 25 mTorr/min, 15 mTorr/min, 10 mTorr/min, 5 mTorr/min, 1 mTorr/min, 0.5 mTorr/min, 0.1 mTorr/min, 0.05 mTorr/min, 0.01 mTorr/min, 0.005 mTorr/min, 0.001 mTorr/min, 0.0005 mTorr/min, or 0.0001 mTorr/min. The leak rate may be between any of the afore-mentioned leak rates (e.g., from about 0.0001 mTorr/min to about, 100 mTorr/min, from about 1 mTorr/min to about, 100 mTorr/min, or from about 1 mTorr/min to about, 100 mTorr/min). The leak rate may be measured by one or more pressure gauges and/or sensors (e.g., at ambient temperature). The enclosure can be sealed such that the leak rate of gas from inside the chamber to an environment outside of the chamber is low (e.g., below a certain level). The seals can comprise O-rings, rubber seals, metal seals, load-locks, or bellows on a piston. In some cases, the chamber can have a controller configured to detect leaks above a specified leak rate (e.g., by using at least one sensor). The sensor may be coupled to a controller. In some instances, the controller is able to identify and/or control (e.g., direct and/or regulate). For example, the controller may be able to identify a leak by detecting a decrease in pressure in side of the chamber over a given time interval.

One or more of the system components can be contained in the enclosure (e.g., chamber). The enclosure can include a reaction space that is suitable for introducing precursor to form a 3D object, such as pre-transformed (e.g., powder) material. The enclosure can contain the platform (e.g., comprising the substrate 109 and the base 102). In some cases, the enclosure can be a vacuum chamber, a positive pressure chamber, or an ambient pressure chamber. The enclosure can comprise a gaseous environment with a controlled pressure, temperature, and/or gas composition. The gas composition in the environment contained by the enclosure can comprise a substantially oxygen free environment. For example, the gas composition can contain at most about 100,000 parts per million (ppm), 10,000 ppm, 1000 ppm, 500 ppm, 400 ppm, 200 ppm, 100 ppm, 50 ppm, 10 ppm, 5 ppm, 1 ppm, 100,000 parts per billion (ppb), 10,000 ppb, 1000 ppb, 500 ppb, 400 ppb, 200 ppb, 100 ppb, 50 ppb, 10 ppb, 5 ppb, 1 ppb, 100,000 parts per trillion (ppt), 10,000 ppt, 1000 ppt, 500 ppt, 400 ppt, 200 ppt, 100 ppt, 50 ppt, 10 ppt, 5 ppt, or 1 ppt oxygen. The gas composition in the environment contained within the enclosure can comprise a substantially moisture (e.g., water) free environment. The gaseous environment can comprise at most about 100,000 ppm, 10,000 ppm, 1000 ppm, 500 ppm, 400 ppm, 200 ppm, 100 ppm, 50 ppm, 10 ppm, 5 ppm, 1 ppm, 100,000 ppb, 10,000 ppb, 1000 ppb, 500 ppb, 400 ppb, 200 ppb, 100 ppb, 50 ppb, 10 ppb, 5 ppb, 1 ppb, 100,000 ppt, 10,000 ppt, 1000 ppt, 500 ppt, 400 ppt, 200 ppt, 100 ppt, 50 ppt, 10 ppt, 5 ppt, or 1 ppt water. The gaseous environment can comprise a gas selected from the group consisting of argon, nitrogen, helium, neon, krypton, xenon, hydrogen, carbon monoxide, carbon dioxide, and oxygen. The gaseous environment can comprise air. The chamber pressure can be at least about 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 760 Torr, 1000 Torr, 1100 Torr, 2 bar, 3 bar, 4 bar, 5 bar, or 10 bar. The chamber pressure can be of any value between the afore-mentioned chamber pressure values (e.g., from about 10⁻⁷ Torr to about 10 bar, from about 10⁻⁷ Torr to about 1 bar, or from about 1 bar to about 10 bar). In some cases, the enclosure pressure can be standard atmospheric pressure. The gas can be an ultrahigh purity gas. The ultrahigh purity gas can be at least about 99%, 99.9%, 99.99%, or 99.999% pure. The gas may comprise less than about 2 ppm oxygen, less than about 3 ppm moisture, less than about 1 ppm hydrocarbons, or less than about 6 ppm nitrogen. The gas can comprise dry air.

The enclosure can be maintained under vacuum and/or under an inert, dry, non-reactive and/or oxygen reduced (or otherwise controlled) atmosphere (e.g., a nitrogen (N₂), helium (He), or argon (Ar) atmosphere). In some examples, the enclosure is under vacuum. In some examples, the enclosure is under pressure of at most about 1 Torr, 10⁻³ Torr, 10⁻⁶ Torr, or 10⁻⁸ Torr. The atmosphere can be furnished by providing an inert, dry, non-reactive, and/or oxygen reduced gas (e.g., Ar). The atmosphere can be furnished by flowing the gas through the enclosure (e.g., chamber).

The system and/or apparatus components described herein can be adapted and configured to generate a 3D object. For example, the system and/or apparatus described herein may comprise a plurality of energy sources (e.g., generating a plurality of energy beams). The plurality may comprise at least 2, 3, 5, 6, 7, 8, 9, or 10 energy sources and/or beams. The plurality may comprise any number of energy sources and/or beams between the afore-mentioned numbers (e.g., from 2 to 10, from 2 to 6, or from 4 to 10). The 3D object can be generated through a 3D printing process. A first layer of pre-transformed material (e.g., powder) can be provided adjacent to a platform. A platform (e.g., base) can be a previously formed layer of the 3D object or any other surface upon which a layer or material bed of pre-transformed material is spread, held, placed, adhered, attached, and/or supported. When the first layer of the 3D object is generated, the first transformed material layer can be formed in the material bed (e.g., without a platform (e.g., base), without one or more auxiliary support features (e.g., rods), or without other supporting structure other than the pre-transformed material (e.g., within the material bed)). Subsequent layers can be formed such that at least one portion of the subsequent layer fused (e.g., melts or sinters) fuses, binds and/or otherwise connects to the at least a portion of a previously formed layer (or portion thereof). The at least a portion of the previously formed layer that can be transformed and optionally subsequently harden into a hardened material. The at least a portion of the previously formed layer that can act as a platform (e.g., base) for formation of the 3D object. In some cases, the first layer comprises at least a portion of the platform (e.g., base). The pre-transformed material layer can comprise particles of homogeneous or heterogeneous size and/or shape.

The system and/or apparatus described herein may comprise at least one energy source (e.g., the transforming energy source generating the transforming energy beam). The energy source may be used to transform at least a portion of the material bed into a transformed material (designated herein also as “transforming energy source”). The transforming energy source may project an energy beam (herein also “transforming energy beam”). The energy source may generate at least one transforming energy beam. The transforming energy beam may be any energy beam (e.g., scanning energy beam, tiling energy beam, or energy flux) disclosed in Patent Applications having serial numbers PCT/US15/36802, PCT/US16/034454, PCT/US16/66000, PCT/US17/18191, 15/374,535, 15/435,078, or EP17156707.6; or in Provisional Patent Applications having Ser. Nos. 62/265,817, 62/307,254 62/317,070, or 62/320,334; all of which are incorporated herein by reference in their entirety. The transforming energy source may be any energy source disclosed in Patent Applications having serial numbers PCT/US15/36802, PCT/US16/034454, PCT/US16/66000, PCT/US17/18191, 15/374,535, 15/435,078, or EP17156707.6; or in Provisional Patent Applications having Ser. Nos. 62/265,817, 62/307,254 62/317,070, or 62/320,334; all of which are incorporated herein by reference in their entirety. The energy beam may travel (e.g., scan) along a path. The path may be predetermined (e.g., by the controller). The methods, systems, software and/or apparatuses may comprise at least a second energy source. The second energy source may generate a second energy (e.g., second energy beam). The first and/or second energy may transform at least a portion of the pre-transformed material in the material bed to a transformed material. In some embodiments, the first and/or second energy source may heat but not transform at least a portion of the pre-transformed material in the material bed. In some cases, the system can comprise 1, 2, 3, 4, 5, 6, 7, 8, 9, 10, 30, 100, 300, 1000 or more energy beams and/or sources. The system can comprise an array of energy sources (e.g., laser diode array). Alternatively, or additionally the surface, material bed, 3D object (or part thereof), or any combination thereof may be heated by a heating mechanism. The heating mechanism may comprise dispersed energy beams. In some cases, the at least one energy source is a single (e.g., first) energy source.

An energy source can be a source configured to deliver energy to an area (e.g., a confined area). An energy source can deliver energy to the confined area through radiative heat transfer. The energy source can project energy (e.g., heat energy, and/or energy beam). The energy (e.g., beam) can interact with at least a portion of the material in the material bed. The energy can heat the material in the material bed before, during and/or after the pre-transformed (e.g., powder) material is being transformed (e.g., melted). The energy can heat at least a fraction of a 3D object at any point during formation of the 3D object. Alternatively, or additionally, the material bed may be heated by a heating mechanism projecting energy (e.g., radiative heat and/or energy beam). The energy may include an energy beam and/or dispersed energy (e.g., radiator or lamp). The energy may include radiative heat. The radiative heat may be projected by a dispersive energy source (e.g., a heating mechanism) comprising a lamp, a strip heater (e.g., mica strip heater, or any combination thereof), a heating rod (e.g., quartz rod), or a radiator (e.g., a panel radiator). The heating mechanism may comprise an inductance heater. The heating mechanism may comprise a resistor (e.g., variable resistor). The resistor may comprise a varistor or rheostat. A multiplicity of resistors may be configured in series, parallel, or any combination thereof. In some cases, the system can have a single (e.g., first) energy source that is used to transform at least a portion of the material bed. An energy source can be a source configured to deliver energy to an area (e.g., a confined area). An energy source can deliver energy to the confined area through radiative heat transfer (e.g., as described herein).

The energy beam may include a radiation comprising an electromagnetic, or charged particle beam. The energy beam may include radiation comprising electromagnetic, electron, positron, proton, plasma, radical, or ionic radiation. The electromagnetic beam may comprise microwave, infrared, ultraviolet, or visible radiation. The energy beam may include an electromagnetic energy beam, electron beam, particle beam, or ion beam. An ion beam may include a cation or an anion. A particle beam may include radicals. The electromagnetic beam may comprise a laser beam. The energy beam may comprise plasma. The energy source may include a laser source. The energy source may include an electron gun. The energy source may include an energy source capable of delivering energy to a point or to an area. In some embodiments, the energy source can be a laser source. The laser may comprise a fiber laser, a solid-state laser or a diode laser. The laser source may comprise a CO₂, Nd:YAG, Neodymium (e.g., neodymium-glass), an Ytterbium, or an excimer laser. The energy source may include an energy source capable of delivering energy to a point or to an area. The energy source (e.g., transforming energy source) can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source can provide an energy beam having an energy density of a value between the afore-mentioned values (e.g., from about 50 J/cm² to about 5000 J/cm², from about 200 J/cm² to about 1500 J/cm², from about 1500 J/cm² to about 2500 J/cm², from about 100 J/cm² to about 3000 J/cm², or from about 2500 J/cm² to about 5000 J/cm²). In an example, a laser can provide light energy at a peak wavelength of at least about 100 nanometer (nm), 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, or 100 nm. The laser can provide light energy at a peak wavelength between any of the afore-mentioned peak wavelength values (e.g., from about 100 nm to about 2000 nm, from about 500 nm to about 1500 nm, or from about 1000 nm to about 1100 nm). The energy source (e.g., laser) may have a power of at least about 0.5 Watt (W), 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy source may have a power of at most about 0.5 W, 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500, 2000 W, 3000 W, or 4000 W. The energy source may have a power between any of the afore-mentioned laser power values (e.g., from about 0.5 W to about 100 W, from about 1 W to about 10 W, from about 100 W to about 1000 W, or from about 1000 W to about 4000 W). The first energy source (e.g., producing the transforming energy beam) may have at least one of the characteristic of the second energy source.

An energy beam(s) from the energy source(s) can be incident on, or be directed perpendicular to, the surface (also herein “target surface”). The surface may be an exposed surface of the material bed or an exposed surface of a hardened (e.g., hard) material. The hardened (e.g., hard) material may be a 3D object or a portion thereof. An energy beam(s) from the energy source(s) can be directed at an acute angle within a value ranging from being parallel to being perpendicular with respect to the average or mean plane of the target surface. The energy beam can be directed onto a specified area of at least a portion of the target surface for a specified time period (e.g., dwell time). The target surface may be the exposed surface of the material bed. The material in target surface (e.g., powder material such as in a top surface of a powder bed) can absorb the energy from the energy beam and, and as a result, a localized region of at least the material at the surface, can increase in temperature. The energy beam can be moveable such that it can translate (e.g., horizontally, vertically, and/or in an angle). The energy source may be movable such that it can translate relative to the target surface. The energy beam(s) can be moved via a scanner (e.g., as disclosed herein). At least two (e.g., all) of the energy sources can be movable with the same scanner. A least two (e.g., all) of the energy beams can be movable with the same scanner. At least two of the energy source(s) and/or beam(s) can be translated independently of each other. In some cases, at least two of the energy source(s) and/or beam(s) can be translated at different rates (e.g., velocities). In some embodiments, at least one scanner is stationary. In some cases, at least two of the energy source(s) and/or beam(s) can be comprise at least one different characteristic. The characteristic of the energy beam may comprise wavelength, charge, power, amplitude, trajectory, footprint, cross-section, focus, intensity, energy, path, or hatching. The charge can be electrical and/or magnetic charge. The characteristic of the energy source may comprise power.

In some embodiments, at least a portion of the layer of pre-transformed material (e.g., first powder layer) is heated by a first energy beam. The portion of the pre-transformed material layer can be heated to a temperature that is greater than or equal to a temperature wherein at least part of the pre-transformed material is transformed to a different state of matter (e.g., at least partially molten). For example, at least a portion of a (solid) powder material can be transformed at least partially to a liquid state (referred to herein as the liquefying temperature) at a given pressure. The portion of the pre-transformed material layer can be heated to a temperature that is greater than or equal to a temperature wherein the entire portion of the pre-transformed material is transformed to a different state of matter (e.g., entirely molten). For example, the liquefying temperature can be equal to a liquidus temperature where the entire material is at a liquid state at a given pressure. The liquefying temperature of the powder material can be the temperature at or above which at least part of the powder material transitions from a solid to a liquid phase at a given pressure. In some examples, the remainder of the pre-transformed material layer can be heated and not transformed (e.g., by the first energy beam or by a different (e.g., second) energy beam). The remainder of the pre-transformed material layer can be at a temperature that is less than the liquefying temperature. The maximum temperature of the transformed portion of the pre-transformed material (e.g., powder) and the temperature of the remainder of the pre-transformed material (e.g., powder) can be different. The solidus temperature of the transformed and/or pre-transformed material can be a temperature wherein the it is in a solid state at a given pressure. In some examples, after the portion of the first layer is heated to the temperature that is greater than or equal to a liquefying temperature of the powder material (e.g., by a first energy beam), the portion of the first layer may be cooled to allow the transformed material portion to harden (e.g., solidify). Once the portion of the first layer hardens, a subsequent (e.g., second) pre-transformed material layer can be provided adjacent to (e.g., above) the first pre-transformed material layer.

The energy source can be an array, or a matrix, of energy sources (e.g., laser diodes). Each of the energy sources in the array, or matrix, can be independently controlled (e.g., by a control mechanism) such that the energy beams can be turned off and on independently. At least a part of the energy sources (e.g., in the array or matrix) can be collectively controlled such that the at least two (e.g., all) of the energy sources can be turned off and on simultaneously. The energy per unit area or intensity of at least two energy sources in the matrix or array can be modulated independently (e.g., by a controller). At times, the energy per unit area or intensity of at least two (e.g., all) of the energy sources (e.g., in the matrix or array) can be modulated collectively (e.g., by a controller). The energy source can scan along the target surface by mechanical movement of the energy source(s), one or more adjustable reflective mirrors one or more polygon light scanners, or any combination or permutation thereof. The energy source(s) can project energy using a DLP modulator, a one-dimensional scanner, a two-dimensional scanner, or any combination thereof. The energy source(s) can be stationary. The material bed (e.g., target surface) may translate vertically, horizontally, or in an angle (e.g., planar or compound). The translation may be effectuated using a scanner.

The energy source can be modulated. The energy beam emitted by the energy source can be modulated. The modulator can include amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an aucusto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam. The focus of the energy beam may be controlled (e.g., modulated).

The energy source and/or energy beam can be moveable such that it can translate relative to the material bed (e.g., target surface). In some instances, the energy source may be movable such that it can translate across (e.g., laterally) the exposed (e.g., top) surface of the material bed. The energy beam(s) can be moved via a scanner. The scanner may comprise a galvanometer scanner, a polygon, a mechanical stage (e.g., X-Y stage), a piezoelectric device, gimble, or any combination of thereof. The galvanometer may comprise a mirror. The scanner may comprise a modulator. The scanner may comprise a polygonal mirror. The scanner can be the same scanner for two or more energy sources and/or beams. The scanner may comprise an optical setup. At least two (e.g., each) energy source and/or beam may have a separate scanner. The energy beams can be translated independently of each other. In some cases, at least two energy sources and/or beams can be translated at different rates, and/or along different paths. For example, the movement of the first energy beam may be faster (e.g., greater rate) as compared to the movement of the second energy beam. The systems and/or apparatuses disclosed herein may comprise one or more shutters (e.g., safety shutters). The energy beam(s), energy source(s), and/or the platform can be moved (e.g., by a scanner or XY stage). The galvanometer scanner may comprise a two-axis galvanometer scanner. The scanner may comprise a modulator (e.g., as described herein). The energy source(s) can project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) and/or energy beam(s) can be modulated. The scanner can be included in an optical system (e.g., optical setup) that is configured to direct energy from the energy source to a predetermined position on the target surface (e.g., exposed surface of the material bed). The controller can be programmed to control a trajectory of the energy source(s) with the aid of the optical system. The controller can regulate a supply of energy from the energy source to the material bed (e.g., at the target surface) to form a transformed material.

The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an aucusto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

The energy beam (e.g., transforming energy beam) may comprise a Gaussian energy beam. The energy beam may have any cross-sectional shape comprising an ellipse (e.g., circle), or a polygon (e.g., as disclosed herein). The energy profile of the energy beam may comprise top-hat or Gaussian. The energy beam may have a cross section with a FLS (e.g., diameter) of at least about 50 micrometers (μm), 100 μm, 150 μm, 200 μm, or 250 μm. The energy beam may have a cross section with a FLS of at most about 60 micrometers (μm), 100 μm, 150 μm, 200 μm, or 250 μm. The energy beam may have a cross section with a FLS of any value between the afore-mentioned values (e.g., from about 50 μm to about 250 μm, from about 50 μm to about 150 μm, or from about 150 μm to about 250 μm). The powder density (e.g., power per unit area) of the energy beam may at least about 10000 W/mm², 20000 W/mm², 30000 W/mm², 50000 W/mm², 60000 W/mm², 70000 W/mm², 80000 W/mm², 90000 W/mm², or 100000 W/mm². The powder density of the energy beam may be at most about 10000 W/mm², 20000 W/mm², 30000 W/mm², 50000 W/mm², 60000 W/mm², 70000 W/mm², 80000 W/mm², 90000 W/mm², or 100000 W/mm². The powder density of the energy beam may be any value between the afore-mentioned values (e.g., from about 10000 W/mm² to about 100000 W/mm², from about 10000 W/mm² to about 50000 W/mm², or from about 50000 W/mm² to about 100000 W/mm²). The scanning speed of the energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the energy beam may be at most about 50 mm/sec, 100 mm/sec, 500 mm/sec, 1000 mm/sec, 2000 mm/sec, 3000 mm/sec, 4000 mm/sec, or 50000 mm/sec. The scanning speed of the energy beam may any value between the afore-mentioned values (e.g., from about 50 mm/sec to about 50000 mm/sec, from about 50 mm/sec to about 3000 mm/sec, or from about 2000 mm/sec to about 50000 mm/sec). The energy beam may be continuous or non-continuous (e.g., pulsing). The energy beam may be modulated before and/or during the formation of a transformed material as part of the 3D object. The energy beam may be modulated before and/or during the 3D printing process. The energy beam characteristics can be any energy beam characteristics disclosed in in Patent Applications having serial numbers PCT/US15/36802, PCT/US16/034454, PCT/US16/66000, PCT/US17/18191, 15/374,535, 15/435,078, or EP17156707.6; or in Provisional Patent Applications having Ser. Nos. 62/265,817, 62/307,254 62/317,070, or 62/320,334; all of which are incorporated herein by reference in their entirety.

The 3D printing system, apparatus, and any of their components may be the one disclosed in Patent Applications having serial numbers PCT/US15/36802, PCT/US16/034454, PCT/US16/66000, PCT/US17/18191, 15/374,535, 15/435,078, or EP17156707.6; or in Provisional Patent Applications having Ser. Nos. 62/265,817, 62/307,254 62/317,070, or 62/320,334; all of which are incorporated herein by reference in their entirety. The 3D printing system or apparatus may comprise a layer dispensing mechanism may dispense the pre-transformed material (e.g., in the direction of the platform), level, distribute, spread, and/or remove the pre-transformed material in the material bed. The layer dispensing mechanism may be utilized to form the material bed. The layer dispensing mechanism may be utilized to form the layer of pre-transformed material (or a portion thereof). The layer dispensing mechanism may be utilized to level (e.g., planarize) the layer of pre-transformed material (or a portion thereof). The leveling may be to a predetermined height. The layer dispensing mechanism may comprise at least one, two or three of a (i) material dispensing mechanism (e.g., FIG. 1, 116), (ii) material leveling mechanism (e.g., FIG. 1, 117), and (iii) material removal mechanism (e.g., FIG. 1, 118). The layer dispensing mechanism may be controlled by the controller. The layer dispensing mechanism or any of its components can be any of those disclosed in Patent Applications having serial numbers PCT/US15/36802, PCT/US16/034454, PCT/US16/66000, PCT/US17/18191, 15/374,535, 15/435,078, or EP17156707.6; or in Provisional Patent Applications having Ser. Nos. 62/265,817, 62/307,254 62/317,070, or 62/320,334; all of which are incorporated herein by reference in their entirety. The layer dispensing system may comprise a hopper. The layer dispensing system may comprise (e.g., may be) a recoater.

One or more sensors (at least one sensor) can detect the topology of the exposed surface of the material bed and/or the exposed surface of the 3D object (or any portion thereof). The sensor can detect the amount of pre-transformed material deposited in the material bed. The sensor can comprise a proximity sensor. For example, the sensor may detect the amount of pre-transformed (e.g., powder) material deposited on the platform or on the exposes surface of a material bed. The sensor may detect the physical state of material deposited on the target surface (e.g., liquid or solid (e.g., powder or bulk)). The sensor can detect the microstructure (e.g., crystallinity) of pre-transformed material deposited on the target surface. The sensor may detect the amount of pre-transformed material disposed by the layer dispensing mechanism (e.g., powder dispenser). The sensor may detect the amount of pre-transformed material that is relocated by the layer dispensing mechanism (e.g., by the leveling mechanism). The sensor can detect the temperature of the pre-transformed and/or transformed material in the material bed. The sensor may detect the temperature of the pre-transformed material in a material (e.g., powder) dispensing mechanism, and/or in the material bed. The sensor may detect the temperature of the pre-transformed material during and/or after its transformation. The sensor may detect the temperature and/or pressure of the atmosphere within the enclosure (e.g., chamber). The sensor may detect the temperature of the material (e.g., powder) bed at one or more locations. The at least one sensor can be operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may comprise temperature sensor, weight sensor, material (e.g., powder) level sensor, metrology sensor, gas sensor, or humidity sensor. The metrology sensor may comprise a measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, and/or electromagnetic signal. The electromagnetic signal may comprise a visible, infrared, ultraviolet, ultrasound, radio wave, or microwave signal. The metrology sensor may measure a vertical, horizontal, and/or angular position of at least a portion of the target surface. The metrology sensor may measure a gap. The metrology sensor may measure at least a portion of the layer of material. The layer of material may be a pre-transformed material (e.g., powder), transformed material, or hardened material. The metrology sensor may measure at least a portion of the 3D object. The gas sensor may sense any of the gas. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may be coupled to a processor that would perform image processing by using at least one sensor generated signal. The temperature sensor may comprise a camera (e.g., IR camera, CCD camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The weight of the material bed can be monitored by one or more weight sensors. The weight sensor(s) may be disposed in, and/or adjacent to the material bed. A weight sensor disposed in the material bed can be disposed at the bottom of the material bed (e.g. adjacent to the platform). The weight sensor can be between the bottom of the enclosure (e.g., FIG. 1, 111) and the substrate (e.g., FIG. 1, 109) on which the base (e.g., FIG. 1, 102) or the material bed (e.g., FIG. 1, 104) may be disposed. The weight sensor can be between the bottom of the enclosure and the base on which the material bed may be disposed. The weight sensor can be between the bottom of the enclosure and the material bed. A weight sensor can comprise a pressure sensor. The weight sensor may comprise a spring scale, a hydraulic scale, a pneumatic scale, or a balance. At least a portion of the pressure sensor can be exposed on a bottom surface of the material bed. The weight sensor can comprise a button load cell. The button load cell can sense pressure from pre-transformed material (e.g., powder) adjacent to the load cell. In an example, one or more sensors (e.g., optical sensors or optical level sensors) can be provided adjacent to the material bed such as above, below, or to the side of the material bed. In some examples, the one or more sensors can sense the level (e.g., height and/or amount) of pre-transformed material in the material bed. The pre-transformed material (e.g., powder) level sensor can be in communication with a layer dispensing mechanism (e.g., powder dispenser). Alternatively, or additionally a sensor can be configured to monitor the weight of the material bed by monitoring a weight of a structure that contains the material bed. One or more position sensors (e.g., height sensors) can measure the height of the material bed relative to the platform. The position sensors can be optical sensors. The position sensors can determine a distance between one or more energy beams (e.g., a laser or an electron beam.) and the exposed surface of the material (e.g., powder) bed. The one or more sensors may be connected to a control system (e.g., to a processor and/or to a computer).

The systems and/or apparatuses disclosed herein may comprise one or more motors. The motors may comprise servomotors. The servomotors may comprise actuated linear lead screw drive motors. The motors may comprise belt drive motors. The motors may comprise rotary encoders. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators. The systems and/or apparatuses disclosed herein may comprise one or more pistons.

In some examples, a pressure system is in fluid communication with the enclosure. The pressure system can be configured to regulate the pressure in the enclosure. In some examples, the pressure system includes one or more pumps. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump, or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valveless pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump.

In some examples, the pressure system includes one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector. The pressure system can include valves; such as throttle valves. The pressure system can include a pressure sensor for measuring the pressure of the chamber and relaying the pressure to the controller, which can regulate the pressure with the aid of one or more vacuum pumps of the pressure system. The pressure sensor can be coupled to a control system (e.g., controller). The pressure can be electronically or manually controlled.

The systems, apparatuses, and/or methods described herein can comprise a material recycling mechanism. The recycling mechanism can collect at least unused pre-transformed material and return the unused pre-transformed material to a reservoir of a material dispensing mechanism (e.g., the material dispensing reservoir), or to a bulk reservoir that feeds the material dispensing mechanism. The recycling mechanism and the bulk reservoir are described in Patent Applications having serial numbers PCT/US15/36802, PCT/US16/034454, PCT/US16/66000, PCT/US17/18191, 15/374,535, 15/435,078, or EP17156707.6; or in Provisional Patent Applications having Ser. Nos. 62/265,817, 62/307,254 62/317,070, or 62/320,334; all of which are incorporated herein by reference in their entirety.

In some cases, unused material (e.g., remainder) can surround the 3D object in the material bed. The unused material can be substantially removed from the 3D object. The unused material may comprise pre-transformed material. Substantial removal may refer to material covering at most about 20%, 15%, 10%, 8%, 6%, 4%, 2%, 1%, 0.5%, or 0.1% of the surface of the 3D object after removal. Substantial removal may refer to removal of all the material that was disposed in the material bed and remained as pre-transformed material at the end of the 3D printing process (i.e., the remainder), except for at most about 10%, 3%, 1%, 0.3%, or 0.1% of the weight of the remainder. Substantial removal may refer to removal of all the remainder except for at most about 50%, 10%, 3%, 1%, 0.3%, or 0.1% of the weight of the printed 3D object. The unused material can be removed to permit retrieval of the 3D object without digging through the material bed. For example, the unused material can be suctioned out of the material bed by one or more vacuum ports (e.g., nozzles) built adjacent to the material bed, by brushing off the remainder of unused material, by lifting the 3D object from the unused material, by allowing the unused material to flow away from the 3D object (e.g., by opening an exit opening port on the side(s) and/or on the bottom of the material bed from which the unused material can exit). After the unused material is evacuated, the 3D object can be removed. The unused pre-transformed material can be re-circulated to a material reservoir for use in future builds. The removal of the remainder may be effectuated as described in Patent Applications having serial numbers PCT/US15/36802, PCT/US16/034454, PCT/US16/66000, PCT/US17/18191, 15/374,535, 15/435,078, or EP17156707.6; or in Provisional Patent Applications having Ser. Nos. 62/265,817, 62/307,254 62/317,070, or 62/320,334; all of which are incorporated herein by reference in their entirety. In some cases, cooling gas can be directed to the hardened material (e.g., 3D object) for cooling the hardened material during and/or following its retrieval.

In some cases, a layer of the 3D object can be formed within at most about 1 hour (h), 30 minutes (min), 20 min, 10 min, 5 min, 1 min, 40 seconds (s), 20 s, 10 s, 9 s, 8 s, 7 s, 6 s, 5 s, 4 s, 3 s, 2 s, or 1 s. A layer of the 3D object can be formed within at least about 30 minutes (min), 20 min, 10 min, 5 min, 1 min, 40 seconds (s), 20 s, 10 s, 9 s, 8 s, 7 s, 6 s, 5 s, 4 s, 3 s, 2 s, or 1 s. A layer of the 3D can be formed within any time between the afore-mentioned time scales (e.g., from about 1 h to about 1 s, from about 10 min to about 1 s, from about 40 s to about 1 s, from about 10 s to about 1 s, or from about 5 s to about is).

In some embodiments, the 3D object is manufactured at a rate which includes the volumetric number of cubic millimeters of transformed material that is formed per second. For example, the rate of formation of a 3D object can be at least about 5 cubic millimeter (mm³)/second (sec), 10 mm³/sec, 15 mm³/sec, 20 mm³/sec, 25 mm³/sec, 30 mm³/sec, 32 mm³/sec, 35 mm³/sec, 40 mm³/sec, 45 mm³/sec, 50 mm³/sec, 55 mm³/sec, 60 mm³/sec, 64 mm³/sec, 65 mm³/sec, 70 mm³/sec, 75 mm³/sec, 80 mm³/sec, 85 mm³/sec, 90 mm³/sec, 95 mm³/sec, or 100 mm³/sec. The rate of formation of a 3D object can be between any of the afore-mentioned values, for example, from about 10 mm³/sec to about 100 mm³/sec, from about 10 mm³/sec to about 30 mm³/sec, from about 32 mm³/sec to about 64 mm³/sec, from about 30 mm³/sec to about 70 mm³/sec or from about 70 mm³/sec to about 100 mm³/sec.

The final form of the 3D object can be retrieved soon after cooling of a final layer of hardened material. Soon after cooling may be at most about 1 day, 12 hours (h), 6 h, 5 h, 4 h, 3 h, 2 h, 1 h, 30 minutes, 15 minutes, 5 minutes, 240 s, 220 s, 200 s, 180 s, 160 s, 140 s, 120 s, 100 s, 80d s, 60 s, 40 s, 20 s, 10 s, 9 s, 8 s, 7 s, 6 s, 5 s, 4 s, 3 s, 2 s, or 1 s. Soon after cooling may be between any of the afore-mentioned time values (e.g., from about is to about 1 day, from about is to about 1 hour, from about 30 minutes to about 1 day, from about 20 s to about 240 s, from about 12 h to about 1 s, from about 12 h to about 30 min, from about 1 h to about 1 s, or from about 30 min to about 40 s). In some cases, the cooling can occur by method comprising active cooling by convection using a cooled gas or gas mixture comprising argon, nitrogen, helium, neon, krypton, xenon, hydrogen, carbon monoxide, carbon dioxide, or oxygen. Cooling may be cooling to a handling temperature. Cooling may be cooling to a temperature that allows a person to handle the 3D object.

The generated 3D object may require very little or no further processing after its retrieval. In some examples, the diminished further processing or lack thereof, will afford a 3D printing process that requires smaller amount of energy and/or less waste as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the afore-mentioned values (e.g., from about 1.1 to about 10, or from about 1.5 to about 5). Further processing may comprise trimming. Further processing may comprise polishing (e.g., sanding). The generated 3D object can be retrieved and finalized without removal of transformed material and/or auxiliary features. The 3D object can be retrieved when the 3D object, composed of hardened (e.g., solidified) material, is at a handling temperature that is suitable to permit its removal from the material bed without its substantial deformation. The handling temperature can be a temperature that is suitable for packaging of the 3D object. The handling temperature a can be at most about 120° C., 100° C., 80° C., 60° C., 40° C., 30° C., 25° C., 20° C., 10° C., or 5° C. The handling temperature can be of any value between the afore-mentioned temperature values (e.g., from about 120° C. to about 20° C., from about 40° C. to about 5° C., or from about 40° C. to about 10° C.).

The methods and systems provided herein can result in fast and/or efficient formation of 3D objects. In some cases, the 3D object can be transported within at most about 120 min, 100 min, 80 min, 60 min, 40 min, 30 min, 20 min, 10 min, or 5 min after the last layer of the object hardens (e.g., solidifies). In some cases, the 3D object can be transported within at least about 120 min, 100 min, 80 min, 60 min, 40 min, 30 min, 20 min, 10 min, or 5 min after the last layer of the object forms (e.g., hardens). In some cases, the 3D object can be transported within any time between the above-mentioned values (e.g., from about 5 min to about 120 min, from about 5 min to about 60 min, or from about 60 min to about 120 min). The 3D object can be transported once it cools to a temperature of at most about 100° C., 90° C., 80° C., 70° C., 60° C., 50° C., 40° C., 30° C., 25° C., 20° C., 15° C., 10° C., or 5° C. The 3D object can be transported once it cools to a temperature value between the above-mentioned temperature values (e.g., from about 5° C. to about 100° C., from about 5° C. to about 40° C., or from about 15° C. to about 40° C.). Transporting the 3D object can comprise packaging and/or labeling the 3D object. In some cases, the 3D object can be transported directly to a consumer.

The methods, systems, apparatuses, and/or software presented herein may facilitate formation of custom or a stock 3D objects for a customer. A customer can be an individual, a corporation, organization, government, non-profit organization, company, hospital, medical practitioner, engineer, retailer, any other entity, or individual. The customer may be one that is interested in receiving the 3D object and/or that ordered the 3D object. A customer can submit a request for formation of a 3D object. The customer can provide an item of value in exchange for the 3D object. The customer can provide a design or a model for the 3D object. The customer can provide the design in the form of a stereo lithography (STL) file. The customer can provide a design wherein the design can be a definition of the shape and/or dimensions of the 3D object in any other numerical or physical form. In some cases, the customer can provide a 3D model, sketch, and/or image as a design of an object to be generated. The design can be transformed in to instructions usable by the printing system to additively generate the 3D object. The customer can provide a request to form the 3D object from a specific material or group of materials (e.g., a material as described herein). In some cases, the design may not contain auxiliary features (or marks of any past presence of auxiliary support features).

In response to the customer request, the 3D object can be formed or generated with the printing method, system and/or apparatus as described herein. In some cases, the 3D object can be formed by an additive 3D printing process (e.g., additive manufacturing). Additively generating the 3D object can comprise successively depositing and transforming (e.g., melting) a pre-transformed material (e.g., powder) comprising one or more materials as specified by the customer. The 3D object can be subsequently delivered to the customer. The 3D object can be formed without generation or removal of auxiliary features (e.g., that is indicative of a presence or removal of the auxiliary support feature). Auxiliary features can be support features that prevent a 3D object from shifting, deforming or moving during the formation of the 3D object.

The 3D object (e.g., solidified material) that is generated for the customer can have an average deviation value from the intended dimensions (e.g., specified by the customer, or designated according to a model of the 3D object) of at most about 0.5 microns (μm), 1 μm, 3 μm, 10 μm, 30 μm, 100 μm, 300 μm, or less. The deviation can be any value between the afore-mentioned values (e.g., from about 0.5 μm to about 300 μm, from about 10 μm to about 50 μm, from about 15 μm to about 85 μm, from about 5 μm to about 45 μm, or from about 15 μm to about 35 μm). The 3D object can have a deviation from the intended dimensions in a specific direction, according to the formula D_{V}+L/K_{Dv}, wherein Dv is a deviation value, L is the length of the 3D object in a specific direction, and K_{Dv} is a constant. Dv can have a value of at most about 300 μm, 200 μm, 100 μm, 50 μm, 40 μm, 30 μm, 20 μm, 10 μm, 5 μm, 1 μm, or 0.5 μm. Dv can have a value of at least about 0.5 μm, 1 μm, 3 μm, 5 μm, 10 μm, 20 μm, 30 μm, 50 μm, 70 μm, 100 μm, or 300 μm. Dv can have any value between the afore-mentioned values (e.g., from about 0.5 μm to about 300 μm, from about 10 μm to about 50 μm, from about 15 μm to about 85 μm, from about 5 μm to about 45 μm, or from about 15 μm to about 35 μm). K_{Dv} can have a value of at most about 3000, 2500, 2000, 1500, 1000, or 500. K_{Dv} can have a value of at least about 500, 1000, 1500, 2000, 2500, or 3000. K_{DV} can have any value between the afore-mentioned values (e.g., from about 3000 to about 500, from about 1000 to about 2500, from about 500 to about 2000, from about 1000 to about 3000, or from about 1000 to about 2500).

The intended dimensions can be derived from a model design. The 3D part can have the stated accuracy value immediately after its formation, without additional processing or manipulation. Receiving the order for the object, formation of the object, and delivery of the object to the customer can take at most about 7 days, 6 days, 5 days, 3 days, 2 days, 1 day, 12 hours, 6 hours, 5 hours, 4 hours, 3 hours, 2 hours, 1 hour, 30 min, 20 min, 10 min, 5 min, 1 min, 30 seconds, or 10 seconds. Receiving the order for the object, formation of the object, and delivery of the object to the customer can take a period of time between any of the afore-mentioned time periods (e.g., from about 10 seconds to about 7 days, from about 10 seconds to about 12 hours, from about 12 hours to about 7 days, or from about 12 hours to about 10 minutes). In some cases, the 3D object can be generated in a period between any of the afore-mentioned time periods (e.g., from about 10 seconds to about 7 days, from about 10 seconds to about 12 hours, from about 12 hours to about 7 days, or from about 12 hours to about 10 minutes). The time can vary based on the physical characteristics of the object, including the size and/or complexity of the object.

The system and/or apparatus can comprise a controlling mechanism (e.g., a controller). The methods, systems, apparatuses, and/or software disclosed herein may incorporate a controller that controls one or more of the components described herein. The controller may comprise a computer-processing unit (e.g., a computer) coupled to any of the systems and/or apparatuses, or their respective components (e.g., the energy source(s)). Alternatively, or additionally, the systems and/or apparatuses disclosed herein may be coupled to a processing unit. Alternatively, or additionally, the methods may incorporate the operation of a processing unit. The computer can be operatively coupled through a wired and/or through a wireless connection. In some cases, the computer can be on board a user device. A user device can be a laptop computer, desktop computer, tablet, smartphone, or another computing device. The controller can be in communication with a cloud computer system and/or a server. The controller can be programmed to selectively direct the energy source(s) to apply energy to the at least a portion of the target surface at a power per unit area. The controller can be in communication with the scanner configured to articulate the energy source(s) to apply energy to at least a portion of the target surface at a power per unit area.

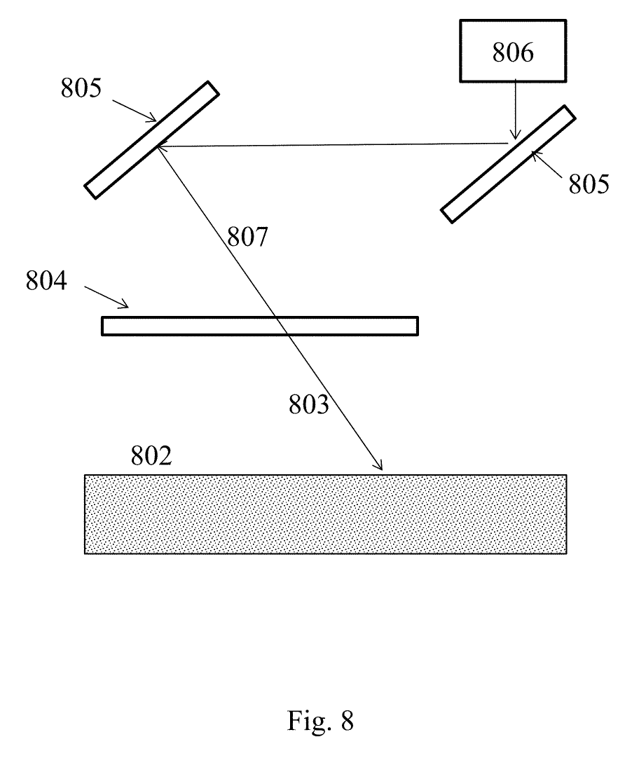

The controller may control the layer dispensing mechanism and/or any of its components. The controller may control the platform. The controller may control the one or more sensors. The controller may control any of the components of the 3D printing system and/or apparatus. The controller may control any of the mechanisms used to effectuate the methods described herein. The control may comprise controlling (e.g., directing and/or regulating) the speed (velocity) of movement of any of the 3D printing mechanisms and/or components. The movement may be horizontal, vertical, and/or in an angle (planar and/or compound). The controller may control at least one characteristic of the transforming energy beam. The controller may control the movement of the transforming energy beam (e.g., according to a path). The controller may control the source of the (transforming) energy beam. The energy beam (e.g., transforming energy beam, or sensing energy beam) may travel through an optical setup. The optical setup may comprise a mirror, a lens, a focusing device, a prism, or an optical window. FIG. 8 shows an example of an optical setup in which an energy beam is projected from the energy source 806, and is deflected by two mirrors 805, and travels through an optical element 804. The optical element 804 can be an optical window, in which case the incoming beam 807 is substantially unaltered 803 after crossing the optical window. The optical element 804 can be a focus altering device, in which case the focus (e.g., cross section) of the incoming beam 807 is altered after passing through the optical element 804 and emerging as the beam 803. The controller may control the scanner that directs the movement of the transforming energy beam and/or platform.

The controller may control the level of pressure (e.g., vacuum, ambient, or positive pressure) in the material removal mechanism material dispensing mechanism, and/or the enclosure (e.g., chamber). The pressure level (e.g., vacuum, ambient, or positive pressure) may be constant or varied. The pressure level may be turned on and off manually and/or by the controller. The controller may control at least one characteristic and/or component of the layer dispensing mechanism. For example, the controller may control the direction and/or rate of movement of the layer dispensing mechanism and any of its components. The controller may control the cooling member (e.g., external and/or internal). The movement of the layer dispensing mechanism or any of its components may be predetermined. The movement of the layer dispensing mechanism or any of its components may be according to an algorithm. Other control a controller examples can be found in Patent Applications having serial numbers PCT/US15/36802, PCT/US16/034454, PCT/US16/66000, PCT/US17/18191, 15/374,535, 15/435,078, or EP17156707.6; or in Provisional Patent Applications having Ser. Nos. 62/265,817, 62/307,254 62/317,070, or 62/320,334; all of which are incorporated herein by reference in their entirety. The control may be manual and/or automatic. The control may be programmed and/or be effectuated a whim. The control may be according to an algorithm. The algorithm may comprise a printing algorithm, or motion control algorithm. The algorithm may take into account the model of the 3D object.

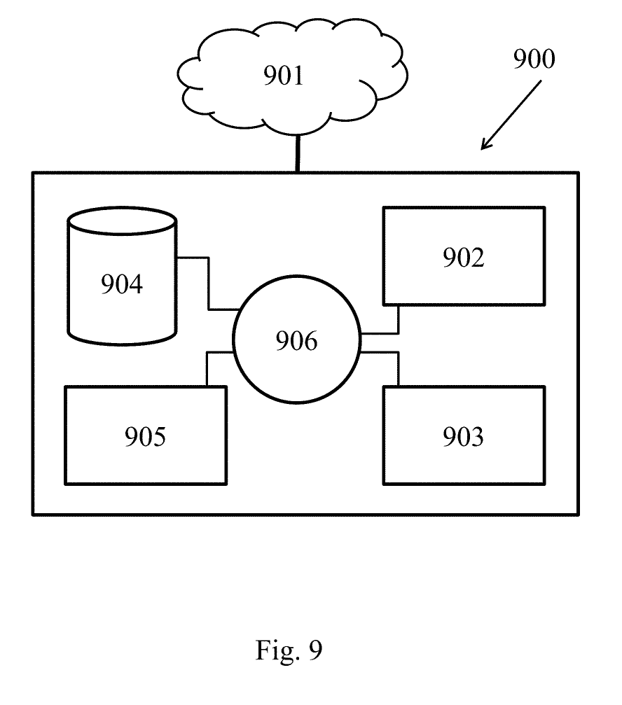

The controller may comprise a processing unit. The processing unit may be central. The processing unit may comprise a central processing unit (herein “CPU”). The controllers or control mechanisms (e.g., comprising a computer system) may be programmed to implement methods of the disclosure. The controller may control at least one component of the systems and/or apparatuses disclosed herein. FIG. 9 is a schematic example of a computer system 900 that is programmed or otherwise configured to facilitate the formation of a 3D object according to the methods provided herein. The computer system 900 can control (e.g., direct and/or regulate) various features of printing methods, apparatuses and systems of the present disclosure, such as, for example, regulating force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system 901 can be part of, or be in communication with, a printing system or apparatus, such as a 3D printing system or apparatus of the present disclosure. The computer may be coupled to one or more mechanisms disclosed herein, and/or any parts thereof. For example, the computer may be coupled to one or more sensors, valves, switches, motors, pumps, optical components, or any combination thereof.

The computer system 900 can include a processing unit 906 (also “processor,” “computer” and “computer processor” used herein). The computer system may include memory or memory location 902 (e.g., random-access memory, read-only memory, flash memory), electronic storage unit 904 (e.g., hard disk), communication interface 903 (e.g., network adapter) for communicating with one or more other systems, and peripheral devices 905, such as cache, other memory, data storage and/or electronic display adapters. The memory 902, storage unit 904, interface 903, and peripheral devices 905 are in communication with the processing unit 906 through a communication bus (solid lines), such as a motherboard. The storage unit can be a data storage unit (or data repository) for storing data. The computer system can be operatively coupled to a computer network (“network”) 901 with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 902. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 900 can be included in the circuit.

The storage unit 904 can store files, such as drivers, libraries, and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory 902 or electronic storage unit 904. The machine executable or machine-readable code can be provided in the form of software. During use, the processor 906 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processor adapted to execute the code, or can be compiled during runtime. The code can be supplied in a programming language that can be selected to enable the code to execute in a pre-compiled or as-compiled fashion.

The processing unit may include one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least about 0.2 billion transistors (BT), 0.5 BT, 1BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The multiplicity of cores can be parallel cores. The multiplicity of cores can function in parallel. The multiplicity of cores may include at least about 2, 10, 40, 100, 400, 1000, 2000, 3000, 4000, 5000, 6000, 7000, 8000, 9000, or 10000 cores. The multiplicity of cores may include at most about 1000, 2000, 3000, 4000, 5000, 6000, 7000, 8000, 9000, 10000, or 40000 cores. The multiplicity of cores may include cores of any number between the afore-mentioned numbers (e.g., from about 2 to about 40000, from about 2 to about 400, from about 400 to about 4000, from about 2000 to about 4000, or from about 4000 to about 10000 cores). The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, or 30 T-FLOPS. The number of FLOPS may be any value between the afore-mentioned values (e.g., from about 1 T-FLOP to about 30 T-FLOP, from about 4 T-FLOPS to about 10 T-FLOPS, from about 1 T-FLOPS to about 10 T-FLOPS, or from about 10 T-FLOPS to about 30 T-FLOPS). The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance UNPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). UNPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

The computer system may include hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by NVidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

The computer system may include an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

The computer system may include configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration.

The computing system may include an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most about 0.1 microsecond (μs), 1 μs, 10 μs, 100 μs, or 1 millisecond (ms). The physical unit may produce the algorithm output in any time between the above-mentioned times (e.g., from about 0.1 μs, to about 1 ms, from about 0.1 μs, to about 100 μs, or from about 0.1 μs to about 10 μs).

In some instances, the controller may use calculations, real time measurements, or any combination thereof to regulate the energy beam(s). The sensor (e.g., temperature and/or positional sensor) may provide a signal (e.g., input for the controller and/or processor) at a rate of at least about 0.1 KHz, 1 KHz, 10 KHz, 100 KHz, 1000 KHz, or 10000 KHz). The sensor may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processing unit may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may be at most about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real-time measurements may be conducted during the 3D printing process. The real-time measurements may be in-situ measurements in the 3D printing system and/or apparatus. the real-time measurements may be during the formation of the 3D object. In some instances, the processing unit may use the signal obtained from the at least one sensor to provide a processing unit output, which output is provided by the processing system at a speed of at most about 100 min, 50 min, 25 min, 15 min, 10 min, 5 min, 1 min, 0.5 min (i.e., 30 sec), 15 sec, 10 sec, 5 sec, 1 sec, 0.5 sec, 0.25 sec, 0.2 sec, 0.1 sec, 80 milliseconds (msec), 50 msec, 10 msec, 5 msec, or 1 msec. In some instances, the processing unit may use the signal obtained from the at least one sensor to provide a processing unit output, which output is provided at a speed of any value between the afore-mentioned values (e.g., from about 100 min to about 1 msec, from about 100 min to about 10 min, from about 10 min to about 1 min, from about 5 min to about 0.5 min, from about 30 sec to about 0.1 sec, or from about 0.1 sec to about 1 msec). The processing unit output may comprise an evaluation of the temperature at a location, position at a location (e.g., vertical, and/or horizontal), or a map of locations. The location may be on the target surface. The map may comprise a topological or temperature map.

The processing unit may use the signal obtained from the at least one sensor in an algorithm that is used in controlling the energy beam. The algorithm may comprise the path of the energy beam. In some instances, the algorithm may be used to alter the path of the energy beam on the target surface. The path may deviate from a cross section of a model corresponding to the desired 3D object. The processing unit may use the output in an algorithm that is used in determining the manner in which a model of the desired 3D object may be sliced. The processing unit may use the signal obtained from the at least one sensor in an algorithm that is used to configure one or more parameters and/or apparatuses relating to the 3D printing process. The parameters may comprise a characteristic of the energy beam. The parameters may comprise movement of the platform and/or material bed. The parameters may comprise relative movement of the energy beam and the material bed. In some instances, the energy beam, the platform (e.g., material bed disposed on the platform), or both may translate. Alternatively, or additionally, the controller may use historical data for the control. Alternatively, or additionally, the processing unit may use historical data in its one or more algorithms. The parameters may comprise the height of the layer of powder material disposed in the enclosure and/or the gap by which the cooling element (e.g., heat sink) is separated from the target surface. The target surface may be the exposed layer of the material bed.

Aspects of the systems, apparatuses, and/or methods provided herein, such as the computer system, can be embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

The memory may comprise a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complement to that of the AND gate. The storage may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

The system and/or apparatus described herein (e.g., controller) and/or any of their components may comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen. The system and/or apparatus described herein (e.g., controller) and/or any of their components may comprise Bluetooth technology. The system and/or apparatus described herein (e.g., controller) and/or any of their components may comprise a communication port. The communication port may be a serial port or a parallel port. The communication port may be a Universal Serial Bus port (i.e., USB). The system and/or apparatus described herein (e.g., controller) and/or any of their components may comprise USB ports. The USB can be micro or mini USB. The USB port may relate to device classes comprising 00 h, 01 h, 02 h, 03 h, 05 h, 06 h, 07 h, 08 h, 09 h, 0Ah, 0Bh, 0Dh, 0Eh, 0Fh, 10 h, 11 h, DCh, E0 h, EFh, FEh, or FFh. The system and/or apparatus described herein (e.g., controller) and/or any of their components may comprise a plug and/or a socket (e.g., electrical, AC power, DC power). The system and/or apparatus described herein (e.g., controller) and/or any of their components may comprise an adapter (e.g., AC and/or DC power adapter). The system and/or apparatus described herein (e.g., controller) and/or any of their components may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

The systems, methods, and/or apparatuses disclosed herein may comprise receiving a request for a 3D object (e.g., from a customer). The request can include a model (e.g., CAD) of the desired 3D object. Alternatively, or additionally, a model of the desired 3D object may be generated. The model may be used to generate 3D printing instructions. The 3D printing instructions may exclude the 3D model. The 3D printing instructions may be based on the 3D model. The 3D printing instructions may take the 3D model into account. The 3D printing instructions may be alternatively or additionally based on simulations. The 3D printing instructions may use the 3D model. The 3D printing instructions may comprise using an algorithm (e.g., embedded in a software) that takes into account the 3D model, simulations, historical data, sensor input, or any combination thereof. The processor may compute the algorithm during the 3D printing process (e.g., in real-time), during the formation of the 3D object, prior to the 3D printing process, after the 3D printing process, or any combination thereof. The processor may compute the algorithm in the interval between pulses of the energy beam, during the dwell time of the energy beam, before the energy beam translates to a new position, while the energy beam is not translating, while the energy beam does not irradiate the target surface, while the energy beam irradiates the target surface, or any combination thereof. For example, the processor may compute the algorithm while the energy beam translates and does substantially not irradiate the exposed surface. For example, the processor may compute the algorithm while the energy beam does not translate and irradiates the exposed surface. For example, the processor may compute the algorithm while the energy beam does not substantially translate and does substantially not irradiate the exposed surface. For example, the processor may compute the algorithm while the energy beam does translate and irradiates the exposed surface. The translation of the energy beam may be translation along an entire path or a portion thereof. The path may correspond to a cross section of the model of the 3D object. The translation of the energy beam may be translation along at least one hatching within the path. FIG. 11 shows examples of various paths. The direction of the arrow(s) in FIG. 11 represents the direction according to which a positon of the energy beam directed to the exposed surface of the material bed is altered with respect to the material bed. The various vectors depicted in FIG. 11, 1114 show an example of various hatchings. The respective movement of the energy beam with the material bed may oscillate while traveling along the path. For example, the propagation of the energy beam along a path may be by small path deviations (e.g., variations such as oscillations). FIG. 10 shows an example of a path 1001. The sub path 1002 is a magnification of a portion of the path 1001 showing path deviations (e.g., oscillations).

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method for printing a three-dimensional object comprising:
(a) modifying a first model of a requested three-dimensional object to form (i) a second model of the requested three-dimensional object from which a segment is omitted, and (ii) a third model of the segment;
(b) printing a modified three-dimensional object above a platform according to the second model, which printing comprises a first three-dimensional printing methodology;
(c) rotating the modified three-dimensional object relative to the platform about an axis that is not perpendicular to the platform; and
(d) printing the segment according to the third model by using a second three-dimensional printing methodology, which printing comprises attaching the segment to the modified three-dimensional object to form the requested three-dimensional object.

2. The method of claim 1, wherein the platform is stationary during the printing in (b) and/or (d).

3. The method of claim 1, wherein the axis forms an acute angle alpha with the platform, wherein alpha is at least ten (10) degrees.

4. The method of claim 1, wherein the printing in (b) comprises using a first material bed, and wherein the method further comprises removing the modified three-dimensional object from the first material bed before (d).

5. The method of claim 1, wherein the printing in (d) comprises using a second material bed to print the requested three-dimensional object.

6. The method of claim 1, wherein the first three-dimensional printing methodology and/or second three-dimensional printing methodology comprises a pre-transformed material that is disposed towards the platform, and is transformed to the transformed material (i) during its disposal towards the platform or (ii) as it contacts the platform.

7. The method of claim 1, wherein the requested three-dimensional object comprises a cavity.

8. The method of claim 7, wherein the cavity comprises an asymmetric cross section.

9. The method of claim 1, further comprising prior to (d) identifying at least one position of the modified three-dimensional object that has been rotated.

10. The method of claim 1, wherein in (d), the segment is printed on the modified three-dimensional object.

11. A system for forming a three-dimensional object comprising:
a platform above which at least a section of the three-dimensional object is printed;
a first processor configured to accommodate a first model of a requested three-dimensional object;
a second processor configured to accommodate a second model of the requested three-dimensional object from which a segment is omitted;
a third processor configured to accommodate a third model of the segment; and
at least one controller that is operatively coupled to the platform, the first processor, the second processor, and the third processor, which at least one controller is programmed to direct performance of the following operations: operation (i) direct the second processor, the first processor, the third processor, or any combination thereof, to modify the first model of the requested three-dimensional object to form the second model and the third model, operation (ii) direct a first printing of the modified three-dimensional object above the platform according to the second model, which first printing comprises a first three-dimensional printing methodology, and operation (iii) direct a second printing the segment according to the third model, which second printing comprises a second three-dimensional printing methodology, which second printing comprises attaching the segment to the modified three-dimensional object that has been rotated relative to the platform, to form the requested three-dimensional object.

12. The system of claim 11, wherein at least two of operation (i), operation (ii), and operation (iii) are directed by the same controller.

13. The system of claim 11, wherein the platform is stationary during the first printing in operation (ii) and/or the second printing in operation (iii).

14. The system of claim 11, wherein the axis forms an acute angle alpha with the platform, wherein alpha is at least ten (10) degrees.

15. The system of claim 11, wherein the segment comprises a protrusion or a cavity.

16. The system of claim 11, wherein the at least one controller is operatively coupled to the modified three-dimensional object, and is programmed to direct rotating the modified three-dimensional object after (ii).

17. The system of claim 11, further comprising a first energy source that is configured to generate a first energy beam that transforms a pre-transformed material to form at least a portion of the modified three-dimensional object, and a second energy source that is configured to generate a second energy beam that transforms a pre-transformed material to form at least a portion of the segment of the three-dimensional object.

18. The system of claim 17, wherein the first energy beam and the second energy beam differ by a least one energy beam characteristic.

19. The system of claim 18, wherein the energy beam characteristic comprises a velocity, cross section, power density, fluence, duty cycle, dwell time, focus, or delay time, wherein the duty cycle comprises a dwell time or a delay time.

20. The system of claim 17, wherein the at least one controller is programmed to direct the first energy beam to transform at least a portion of the pre-transformed material to form at least a portion of the modified three-dimensional object, and wherein the at least one controller is programmed to direct the second energy beam to transform at least a portion of the pre-transformed material to form the segment of the three-dimensional object.
